(19) United States
(12) Patent Application Publication
(10) Pub. No.: US 2014/0191832 A1
(43) Pub. Date: Jul. 10, 2014

(54) PRIMARY ULTRAFINE-CRYSTALLINE ALLOY RIBBON AND ITS CUTTING METHOD, AND NANO-CRYSTALLINE, SOFT MAGNETIC ALLOY RIBBON AND MAGNETIC DEVICE USING IT

(71) Applicants: Motoki Ohta, Mishima-gun (JP); Yoshihito Yoshizawa, Mishima-gun (JP)

(72) Inventors: Motoki Ohta, Mishima-gun (JP); Yoshihito Yoshizawa, Mishima-gun (JP)

(73) Assignee: HITACHI METALS, LTD., Minato-ku, Tokyo (JP)

(21) Appl. No.: 14/239,682

(22) PCT Filed: Sep. 11, 2012
(86) PCT No.: PCT/JP2012/073160

§ 371 Date: Feb. 19, 2014

(30) Foreign Application Priority Data
Oct. 3, 2011 (JP) 2011-219094

(51) Int. Cl. H01F 1/153; B26F 3/00; C22C 45/02

(52) U.S. Cl. CPC H01F 1/15308; C22C 45/02; B26F 3/00; C22C 45/00
USPC 335/302; 148/403; 148/304; 225/1

(57) ABSTRACT

A method for cutting a primary ultrafine-crystalline alloy ribbon having a structure in which ultrafine crystal grains having an average grain size of 30 nm or less are dispersed in a proportion of 5-30% by volume in an amorphous matrix, comprising placing the ribbon on a soft base deformable to an acute angle by local pressing, bringing a cutter blade into horizontal contact with a surface of the ribbon, and pressing the cutter to the ribbon to apply uniform pressure thereto, thereby bending the ribbon along a cutter blade edge to brittly fracture-cut the ribbon.

### FIELD OF THE INVENTION

The present invention relates to a primary ultrafine-crystalline alloy ribbon which can stably be cut linearly, a method for linearly cutting the primary ultrafine-crystalline alloy ribbon by brittle fracture, a nanocrystalline, soft magnetic alloy ribbon having excellent soft magnetic properties with a smoothly cut portion substantially free from jagged fracture and cracks, and a magnetic device formed thereby.

### BACKGROUND OF THE INVENTION

Soft magnetic materials used for various reactors, choke coils, magnetic pulse power devices, transformers, magnetic cores for motors and power generators, current sensors, magnetic sensors, antenna cores, electromagnetic-wave-absorbing sheets, etc. include silicon steel, ferrite, Co-based, amorphous, soft magnetic alloys, Fe-based, amorphous, soft magnetic alloys and Fe-based, fine-crystalline, soft magnetic alloys, etc. Silicon steel is inexpensive and has a high magnetic flux density, but it suffers large core loss at high frequencies, and it cannot easily be made thin. Because of a low saturation magnetic flux density, ferrite is easily saturated magnetically in high-power applications with large operation magnetic flux densities. Co-based, amorphous, soft magnetic alloys are expensive and have as low saturation magnetic flux densities as 1 T or less, providing large parts when used for high-power applications. In addition, because of thermal instability, the Co-based, amorphous, soft magnetic alloys suffer core loss increasing with time. Fe-based, amorphous, soft magnetic alloys have as low saturation magnetic flux densities as about 1.5 T, with insufficiently low coercivity. However, these amorphous alloy ribbons can be easily cut by shearing cutters such as scissors, etc. because of high toughness.

As an Fe-based, fine-crystalline, soft magnetic alloy having higher soft magnetic properties than those of amorphous alloy ribbons, WO 2007/032531 discloses an Fe-based, fine-crystalline, soft magnetic alloy having a composition represented by the formula of Fe_{100-x-y-z}CuₓB_{y}X_{z}, wherein X is at least one element selected from the group consisting of Si, S, C, P, Al, Ge, Ga and Be, and x, y and z are numbers meeting the conditions of 0.1≦x≦3, 10≦y≦20, 0<z≦10, and 10<y+z≦24, respectively, when expressed by atomic %, and a structure in which crystal grains having an average grain size of 60 nm or less are dispersed in a proportion of 30% or more by volume in an amorphous matrix, thereby having a high saturation magnetic flux density of 1.7 T or more and low coercivity. This Fe-based, fine-crystalline, soft magnetic alloy is produced by quenching an Fe-based alloy melt to form an ultrafine-crystalline alloy ribbon comprising fine crystal grains having an average grain size of 30 nm or less dispersed in a proportion of less than 30% by volume in an amorphous phase, and subjecting this ultrafine-crystalline alloy ribbon to a high-temperature, short-time heat treatment or a low-temperature, long-time heat treatment.

WO 2010/084888 discloses a method for producing a soft magnetic alloy ribbon having a composition represented by Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions by atomic % of 0<x≦5, 10≦y≦22, 1≦z≦10, and x+y+z≦25, respectively, and a matrix structure in which fine crystal grains having an average grain size of 60 nm or less are dispersed in a volume fraction of 50% or more in an amorphous phase, and further having an amorphous layer having higher B concentration than in the matrix in a depth range of 30-130 nm from the surface, the method comprising the steps of (1) ejecting an alloy melt having the above composition onto a rotating cooling roll for quenching, thereby forming a primary fine-crystalline alloy ribbon having a matrix structure in which fine crystal nuclei having an average grain size of 30 nm or less are dispersed in a volume fraction of more than 0% and less than 30% in an amorphous phase; and stripping the primary fine-crystalline alloy ribbon from the cooling roll when the temperature reaches 170-350° C., and then (2) subjecting the primary fine-crystalline alloy ribbon to a heat treatment in an atmosphere containing oxygen in a low concentration.

The ultrafine-crystalline alloy ribbon of WO 2007/032531 or the primary fine-crystalline alloy ribbon of WO 2010/084888 is heat-treated after lamination or winding, to form magnetic devices such as transformers, reactors, choke coils, etc. having desired soft magnetic properties. Before lamination or winding, these ribbons should be cut to predetermined sizes. However, the alloy ribbons of WO 2007/032531 and WO 2010/084888 having structures in which ultrafine crystal grains are precipitated are extremely brittle with high hardness. It has been found that if cutting were tried by a shearing cutter 22 such as scissors, etc. as shown in FIG. 8, pluralities of cracks 11, 11 would propagate radially from pressured points 22a, resulting in extreme fracture. Also, even if they were tried to be broken along scratch lines formed by a glasscutter, etc., linear fracture would not be obtained along the scratch lines.

Further, a wider alloy ribbon having a structure in which ultrafine crystal grains are precipitated would be more difficult to be cut along a straight line without extremely jagged breakage, etc. A rectangular cross section would not be obtained without cutting an alloy ribbon along a straight line, so that a magnetic flux density, etc. cannot be evaluated accurately. Further, magnetic devices such as wound cores, etc. formed by such alloy ribbons would not have stable quality (soft magnetic properties), and would suffer cracking from the jagged cut portion by a heat treatment, etc.

### OBJECT OF THE INVENTION

Accordingly, an object of the present invention is to provide a primary ultrafine-crystalline alloy ribbon having a structure in which ultrafine crystal grains are precipitated, and capable of being cut along a straight line with little jagged breakage, etc., a method for cutting such a primary ultrafine-crystalline alloy ribbon along a straight line easily and surely, and a nanocrystalline, soft magnetic alloy ribbon obtained by heat-treating the cut primary ultrafine-crystalline alloy ribbon, and a magnetic device formed thereby.

### DISCLOSURE OF THE INVENTION

As a result of intensive research in view of the above object, it has been found that (a) with a primary ultrafine-crystalline alloy ribbon having a structure comprising precipitated ultrafine crystal grains placed on an elastically deformable, soft base, a cutter blade is pressed to a surface of the ribbon simultaneously over the entire length to sharply bend the ribbon, so that the ribbon can be fracture-cut along the cutter blade, and (b) when the ribbon has hardness in a predetermined range with small hardness distribution, fracture-cutting can provide a smooth straight cut portion with little jagged breakage, etc. The present invention has been completed based on such findings.

Thus, the primary ultrafine-crystalline alloy ribbon of the present invention has a composition represented by the general formula of Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions of 0<x≦5, 10≦y≦22, 0≦z≦10, and x+y+z≦25, respectively, when expressed by atomic %, and a structure in which ultrafine crystal grains having an average grain size of 30 nm or less are dispersed in a proportion of 5-30% by volume in an amorphous matrix;

the primary ultrafine-crystalline alloy ribbon having a width of 10 mm or more and a thickness of 15 μm or more, with thickness difference of 2 μm or less in a transverse direction;

the primary ultrafine-crystalline alloy ribbon having Vickers hardness Hv (measured at a load of 100 g) of 850-1150 in both center and side portions in a transverse direction; and the difference of Vickers hardness Hv (measured at a load of 100 g) between the center portion and the side portions being 150 or less.

In an embodiment of the present invention, the primary ultrafine-crystalline alloy ribbon has higher Vickers hardness Hv (measured at a load of 100 g) in the center portion than in the side portions.

The primary ultrafine-crystalline alloy ribbon preferably has Vickers hardness Hv (measured at a load of 100 g) of 850-1100 in both center and side portions in a transverse direction.

The method of the present invention for cutting a primary ultrafine-crystalline alloy ribbon having a structure in which ultrafine crystal grains having an average grain size of 30 nm or less are dispersed in a proportion of 5-30% by volume in an amorphous matrix; the ribbon having a width of 10 mm or more and a thickness of 15 μm or more, with thickness difference being 2 μm or less in a transverse direction, and having Vickers hardness Hv (measured at a load of 100 g) of 850-1150 in both center and side portions in a transverse direction, the difference of Vickers hardness Hv (measured at a load of 100 g) between the center portion and the side portions being 150 or less; comprises the steps of

placing the primary ultrafine-crystalline alloy ribbon on a soft base deformable to an acute angle by local pressing;

bringing a cutter blade into horizontal contact with a surface of the primary ultrafine-crystalline alloy ribbon; and

pressing the cutter to the primary ultrafine-crystalline alloy ribbon to apply uniform pressure thereto, thereby bending the primary ultrafine-crystalline alloy ribbon along a blade edge of the cutter to fracture-cut it.

The base is preferably a laminate of an upper layer formed by a rubber sheet and a lower layer formed by a sponge. The rubber sheet is preferably a sheet of natural or synthetic rubber having a thickness of 0.3-2 mm, and the sponge is preferably a foamed rubber or resin having a thickness of 2-30 mm.

The nanocrystalline, soft magnetic alloy ribbon of the present invention is characterized in that (a) it is obtained by heat-treating a primary ultrafine-crystalline alloy ribbon having a composition represented by the general formula of Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions of 0<x≦5, 10≦y≦22, 0≦z≦10, and x+y+z≦25, respectively, when expressed by atomic %, and having a structure in which ultrafine crystal grains having an average grain size of 30 nm or less are dispersed in a proportion of 5-30% by volume in an amorphous matrix; the primary ultrafine-crystalline alloy ribbon having a width of 10 mm or more and a thickness of 15 μm or more, with thickness difference of 2 μm or less in a transverse direction, and Vickers hardness Hv (measured at a load of 100 g) of 850-1150 in both center and side portions in a transverse direction, the difference of Vickers hardness Hv (measured at a load of 100 g) between the center portion and the side portions being 150 or less; that (b) the nanocrystalline, soft magnetic alloy ribbon has a structure in which fine crystal grains having an average grain size of 60 nm or less are dispersed in a proportion of 30% or more by volume in an amorphous matrix; that (c) the nanocrystalline, soft magnetic alloy ribbon is fracture-cut along a cutter blade in horizontal contact with a surface of the ribbon before or after the heat treatment; and that (d) when notches are generated along the fracture-cut portion of the ribbon, the percentage of the notches is 5% or less, which is determined by the following formula:

Percentage of notches=(Dav/D)×100(%),

wherein D is the width of the ribbon, Dav is an average depth of the notches, which is obtained by dividing the total area of the notches by the width D of the ribbon.

The cut portion at least partially has a brittly fractured cross section. The cut portion may further have partially plastically deformed regions. The notches are preferably free from acute-angle corners.

The magnetic device of the present invention is formed by the above nanocrystalline, soft magnetic alloy ribbon.

### BRIEF DESCRIPTION OF THE DRAWINGS

FIG. 1(a) is a cross-sectional view showing a step in which a cutter blade is brought into horizontal contact with a primary ultrafine-crystalline alloy ribbon placed on a base in the linear pressing method of the present invention.

FIG. 1(b) is a front view showing a step in which a cutter blade is brought into horizontal contact with a primary ultrafine-crystalline alloy ribbon placed on a base in the linear pressing method of the present invention.

FIG. 1(c) is a cross-sectional view showing a step in which a cutter blade is pressed to the primary ultrafine-crystalline alloy ribbon in the linear pressing method of the present invention.

FIG. 1(d) is a cross-sectional view showing a step in which the primary ultrafine-crystalline alloy ribbon is fracture-cut by pressing the cutter blade in the linear pressing method of the present invention.

FIG. 2(a) is an enlarged cross-sectional view showing cracks generated in the primary ultrafine-crystalline alloy ribbon by pressing the cutter blade in the step of FIG. 1(c).

FIG. 2(b) is an enlarged cross-sectional view showing a state in which cracks generated by pressing the cutter blade have penetrated the primary ultrafine-crystalline alloy ribbon in the step of FIG. 1(d).

FIG. 3 is an enlarged plan view showing a mechanism of fracture-cutting the primary ultrafine-crystalline alloy ribbon in the linear pressing method of the present invention.

FIG. 4 is a plan view showing notches in the vicinity of a cut portion of the primary ultrafine-crystalline alloy ribbon cut by the linear pressing method of the present invention.

FIG. 5 is a schematic view for explaining a method for measuring the Vickers hardness of the primary ultrafine-crystalline alloy ribbon.

FIG. 6 is a photomicrograph showing a fracture-cut cross section of the primary ultrafine-crystalline alloy ribbon of Example 1.

FIG. 7 is a photomicrograph showing a fracture-cut cross section of the primary ultrafine-crystalline alloy ribbon of Example 4.

FIG. 8 is a schematic cross-sectional view showing the propagation of cracks when the primary ultrafine-crystalline alloy ribbon is cut by a shearing cutter.

### DESCRIPTION OF THE PREFERRED EMBODIMENTS

### [1] Primary Ultrafine-Crystalline Alloy Ribbon

(1) Composition

The primary ultrafine-crystalline alloy ribbon of the present invention has a composition represented by the general formula of Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions of 0<x≦5, 10≦y≦22, 0≦z≦10, and x+y+z≦25, respectively, when expressed by atomic %. Of course, the above composition may contain inevitable impurities. To have a saturation magnetic flux density Bs of 1.7 T or more, the alloy should have a fine crystal (nano-crystal) structure of bcc-Fe. For this purpose, it should have a high Fe content. Specifically, the Fe content should be 75 atomic % or more, is preferably 77 atomic % or more, more preferably 78 atomic % or more.

In the above composition, the saturation magnetic flux density Bs is 1.7 T or more when 0.1≦x≦3, 10≦y≦20, 0≦z≦10, and 10<y+z≦24, 1.74 T or more when 0.1≦x≦3, 12≦y≦17, 0<z≦7, and 13≦y+z≦20, 1.78 T or more when 0.1≦x≦3, 12≦y≦15, 0<z≦5, and 14≦y+z≦19, and 1.8 T or more when 0.1≦x≦3, 12≦y≦15, 0<z≦4, and 14≦y+z≦17.

To have good soft magnetic properties, specifically coercivity of 24 A/m or less, preferably 12 A/m or less, and a saturation magnetic flux density Bs of 1.7 T or more, the primary ultrafine-crystalline alloy has an Fe—B-based composition stably providing an amorphous phase even at a high Fe content, to which a nucleus-forming element A (Cu and/or Au) insoluble in Fe is added. Specifically, when Cu and/or Au insoluble in Fe is added to an Fe—B-based alloy comprising 88 atomic % or less of Fe for stably having a main amorphous phase, ultrafine crystal grains are precipitated therein. The ultrafine crystal grains uniformly grow to fine crystal grains by a subsequent heat treatment.

Too small an amount (x) of the element A makes the precipitation of ultrafine crystal grains difficult, and more than 5 atomic % of the element A makes the ribbon brittle by quenching. From the aspect of cost, the element A is preferably Cu. Because more than 3 atomic % of Cu tends to deteriorate soft magnetic properties, the Cu content (x) is preferably 0.3-2 atomic %, more preferably 1-1.7 atomic %, most preferably 1.2-1.6 atomic %. When Au is added, it is preferably 1.5 atomic % or less.

B (boron) is an element accelerating the formation of an amorphous phase. When B is less than 10 atomic %, it is difficult to obtain a primary ultrafine-crystalline alloy ribbon having an amorphous phase as a main phase. When B exceeds 22 atomic %, the resultant alloy ribbon has a saturation magnetic flux density of less than 1.7 T. Accordingly, the B content (y) should meet the condition of 10≦y≦22. The B content (y) is preferably 11-20 atomic %, more preferably 12-18 atomic %, most preferably 12-17 atomic %.

The element X is at least one element selected from the group consisting of Si, S, C, P, Al, Ge, Ga and Be, particularly Si. The addition of the element X makes the precipitation temperature of Fe—B or Fe—P (when P is added) having large crystal magnetic anisotropy higher, enabling a higher heat treatment temperature. A high-temperature heat treatment increases the percentage of fine crystal grains, resulting in increased Bs and an improved squareness ratio of the B—H curve. Though the lower limit of the amount (z) of the element X may be 0 atomic %, 1 atomic % or more of the element X forms its oxide layer on the ribbon surface, sufficiently suppressing the internal oxidation of the ribbon. On the other hand, more than 10 atomic % of the element X content (z) provides less than 1.7 T of Bs. The element X content (z) is preferably 2-9 atomic %, more preferably 3-8 atomic %, most preferably 4-7 atomic %.

Among the element X, P is an element improving the formability of the amorphous phase, while suppressing the growth of fine crystal grains, and the segregation of B in the oxide layer. Accordingly, P is preferable for high toughness, high Bs and good soft magnetic properties. The use of S, C, Al, Ge, Ga or Be as the element X makes it possible to control magnetostriction and magnetic properties.

Part of Fe may be substituted by at least one element D selected from Ni, Mn, Co, V, Cr, Ti, Zr, Nb, Mo, Hf, Ta and W. The amount of the element D is preferably 0.01-10 atomic %, more preferably 0.01-3 atomic %, most preferably 0.01-1.5 atomic %. Among the element D, Ni, Mn, Co, V and Cr have an effect of shifting a high-B-concentration region toward the surface, forming a structure close to the matrix from near the surface, thereby improving the soft magnetic properties (permeability, coercivity, etc.) of the soft magnetic alloy ribbon. Also, the element D is contained predominantly in an amorphous phase remaining after the heat treatment together with the element A and metalloid elements such as B, Si, etc., suppressing the growth of fine crystal grains having a high Fe content, and reducing the average grain size of fine crystal grains, thereby improving the saturation magnetic flux density Bs and soft magnetic properties.

Particularly when part of Fe is substituted by Co or Ni soluble in Fe together with the element A, the amount of the element A which can be added increases, thereby making the crystal structure finer, and improving the soft magnetic properties. The Ni content is preferably 0.1-2 atomic %, more preferably 0.5-1 atomic %. Less than 0.1 atomic % of Ni provides an insufficient effect of improving handleability (fracture-cuttability and windability), while more than 2 atomic % of Ni decreases Bₛ, B₈₀ and H_{c}. The Co content is also preferably 0.1-2 atomic %, more preferably 0.5-1 atomic %.

Ti, Zr, Nb, Mo, Hf, Ta and W are also contained predominantly in an amorphous phase remaining after the heat treatment together with the element A and metalloid elements, contributing to the improvement of the saturation magnetic flux density Bs and soft magnetic properties. On the other hand, too a large amount of such element having a large atomic weight results in a low Fe content per a unit weight, and thus poor soft magnetic properties. The total amount of these elements is preferably 3 atomic % or less. Particularly in the case of Nb and Zr, their total amount is preferably 2.5 atomic % or less, more preferably 1.5 atomic % or less. In the case of Ta and Hf, their total amount is preferably 1.5 atomic % or less, more preferably 0.8 atomic % or less.

Part of Fe may be substituted by at least one element selected from the group consisting of Re, Y, Zn, As, Ag, In, Sn, Sb, platinum-group elements, Bi, N, O, and rare earth elements. The total amount of these elements is preferably 5 atomic % or less, more preferably 2 atomic % or less. Particularly to obtain a high saturation magnetic flux density, the total amount of these elements is preferably 1.5 atomic % or less, more preferably 1.0 atomic % or less.

(2) Structure

The primary ultrafine-crystalline alloy ribbon has a structure in which ultrafine crystal grains having an average grain size of 30 nm or less are dispersed in a proportion of 5-30% by volume in an amorphous matrix. When the average grain size of ultrafine crystal grains exceeds 30 nm, fine crystal grains formed by the heat treatment are made larger, resulting in deteriorated soft magnetic properties. The lower limit of the average grain size of ultrafine crystal grains is about 0.5 nm because of measurement limitation, and preferably 1 nm, more preferably 2 nm or more. To obtain excellent soft magnetic properties, the average grain size of ultrafine crystal grains is preferably 5-25 nm, more preferably 5-20 nm. In the Ni-containing composition, the average grain size of ultrafine crystal grains is preferably about 5-15 nm. When the volume fraction of ultrafine crystal grains exceeds 30% by volume in the primary ultrafine-crystalline alloy ribbon, ultrafine crystal grains tend to have an average grain size exceeding 30 nm, making the primary ultrafine-crystalline alloy ribbon too brittle. However, the absence of ultrafine crystal grains (completely amorphous) tends to make crystal grains larger by the heat treatment. In the primary ultrafine-crystalline alloy ribbon, the volume fraction of ultrafine crystal grains is preferably 5-25%, more preferably 5-20%.

When an average distance between ultrafine crystal grains (average distance between their centers of gravity) is 50 nm or less, the magnetic anisotropy of fine crystal grains is preferably averaged to reduce effective crystal magnetic anisotropy. When the average distance exceeds 50 nm, the magnetic anisotropy is less averaged, resulting in higher effective crystal magnetic anisotropy and poorer soft magnetic properties. Accordingly, the average distance between ultrafine crystal grains is preferably 50 nm or less.

### [2] Cutting

Because the amorphous alloy ribbon comprising no ultrafine crystal grains dispersed in an amorphous matrix has high toughness, it can be cut by a so-called “shear-cutting mode” with scissors, etc. Because the shear-cutting mode is basically cutting by plastic deformation (shearing), it provides a smoothly cut cross section.

In the primary ultrafine-crystalline alloy ribbon having a structure in which ultrafine crystal grains having an average grain size of 30 nm or less are dispersed in a proportion of 5-30% by volume in an amorphous matrix, however, cracks propagate through paths between high-hardness, ultrafine crystal grains. Accordingly, when stress is applied to one point in the shear-cutting mode, a crack propagates from this point toward the closest ultrafine crystal grain. Because ultrafine crystal grains are dispersed randomly, cracks propagate randomly, failing to conduct straight cutting. Thus, the shear-cutting mode cannot be used in the primary ultrafine-crystalline alloy ribbon.

Intensive research has revealed that by conducting a so-called “linear pressing method” comprising the steps of (a) placing the primary ultrafine-crystalline alloy ribbon on a soft base deformable to an acute angle by local pressing, (b) placing (abutting) a cutter blade substantially horizontally to a surface of the primary ultrafine-crystalline alloy ribbon, and (c) pressing the cutter to the primary ultrafine-crystalline alloy ribbon to apply substantially uniform pressure thereto, the primary ultrafine-crystalline alloy ribbon can be fracture-cut along a straight line substantially without cracking and jagged breakage. The linear pressing method will be explained in detail below.

(1) Linear Pressing Method

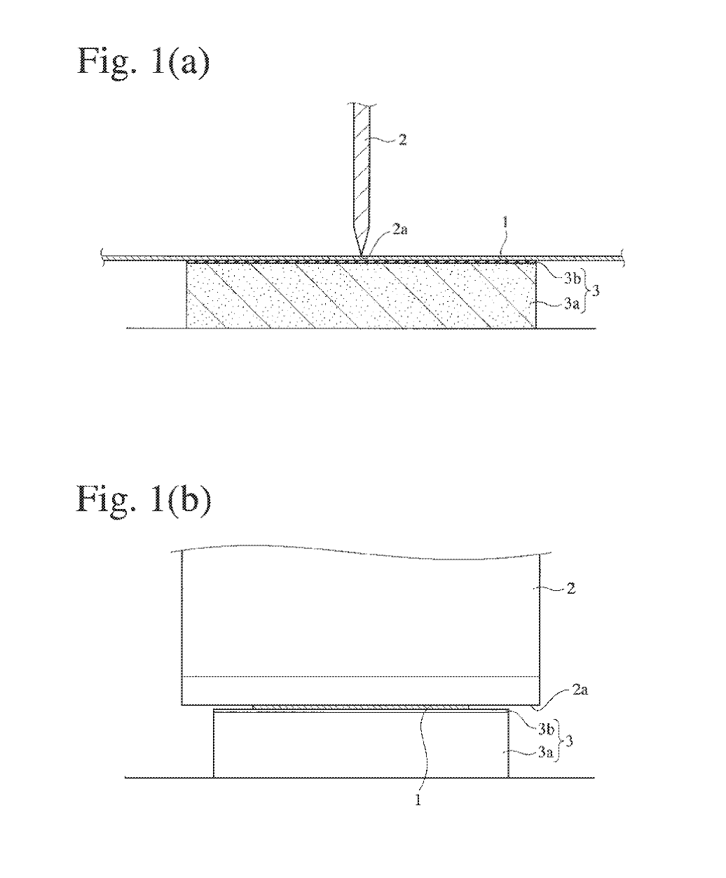

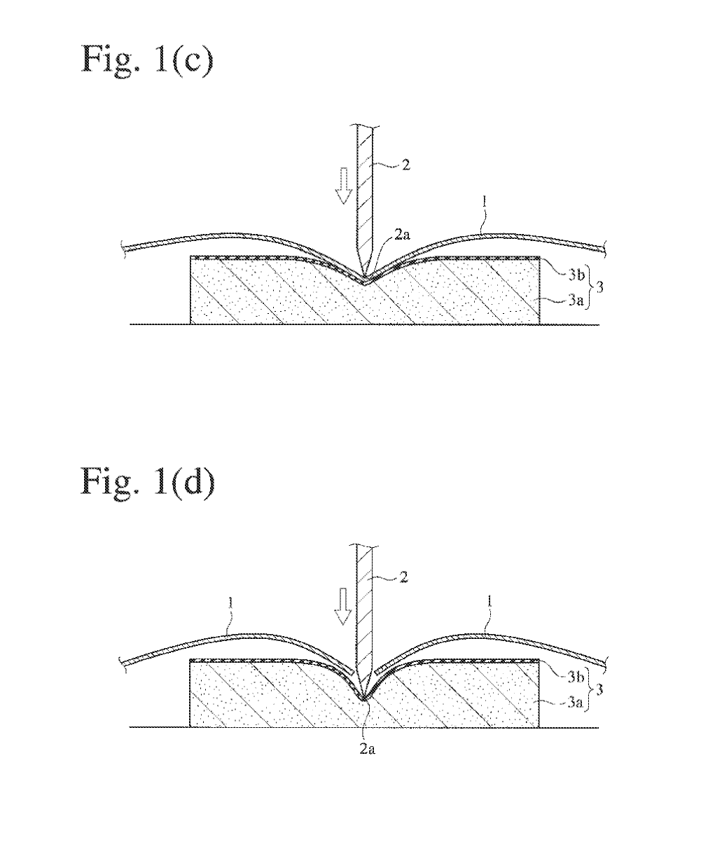

As shown in FIGS. 1(a) and 1(b), a primary ultrafine-crystalline alloy ribbon 1 is placed on a soft base 3 deformable to an acute angle by local pressing, and a blade 2a of a cutter 2 is brought into horizontal contact with a surface of the primary ultrafine-crystalline alloy ribbon 1. As shown in FIG. 1(c), the blade 2a of the cutter 2 is then uniformly pressed to the primary ultrafine-crystalline alloy ribbon 1 to apply uniform pressure thereto. As a result, the base 3 is so deformed that the primary ultrafine-crystalline alloy ribbon 1 is sharply bent along the blade 2a of the cutter 2, and thus subject to a breaking force. With the cutter 2 further pressed as shown in FIG. 1(d), the bent primary ultrafine-crystalline alloy ribbon 1 reaches a brittle fracture limit, so that it is fractured substantially linearly along the blade 2a of the cutter 2. This brittle fracture along the blade 2a of the cutter 2 is called “fracture-cutting.”

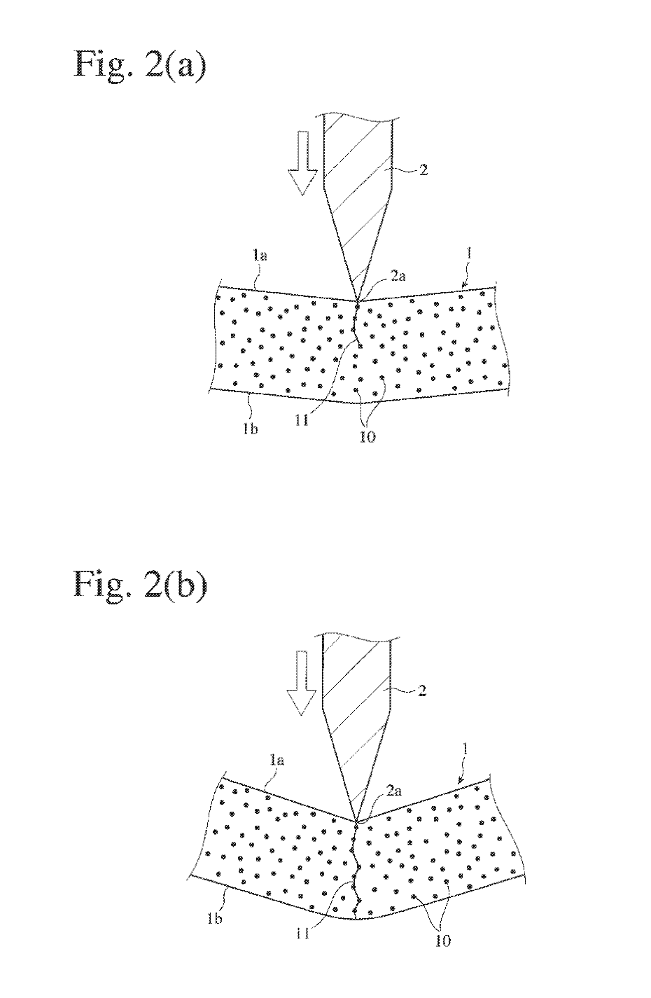

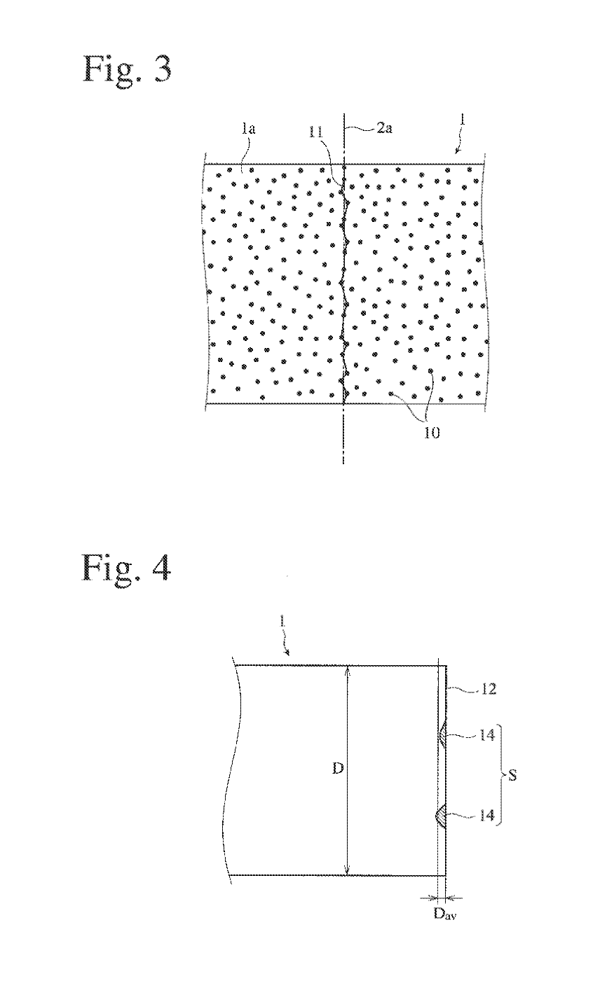

As shown in FIG. 2(a), when the blade 2a of the cutter 2 in contact with an upper surface 1a of the primary ultrafine-crystalline alloy ribbon 1 is pushed down, the primary ultrafine-crystalline alloy ribbon 1 is bent, so that cracks 11 propagate along ultrafine crystal grains 10 precipitated in its amorphous matrix. With the cutter 2 further pushed down as shown in FIG. 2(b), the primary ultrafine-crystalline alloy ribbon 1 is sharply bent, and cracks 11 reach its lower surface 1b, so that the primary ultrafine-crystalline alloy ribbon 1 is brittly fractured along the crack 11. When viewed microscopically as shown in FIG. 3, the blade 2a of the cutter 2 horizontally pressed to an upper surface 1a of the primary ultrafine-crystalline alloy ribbon 1 comes into contact with large numbers of ultrafine crystal grains 10, so that cracks 11 simultaneously propagating from the ultrafine crystal grains 10 in contact with the blade 2a of the cutter 2 and those nearby are connected in short distances. Thus, the cracks 11 are connected without propagating far from the blade 2a of the cutter 2. As a result, the primary ultrafine-crystalline alloy ribbon 1 is brittly fractured substantially along the blade 2a of the cutter 2 when viewed macroscopically. Accordingly, a cut portion obtained by the brittle fracture (fracture-cutting) by the linear pressing method of the present invention is substantially straight. Because it may be said that the primary ultrafine-crystalline alloy ribbon 1 is fractured by cracks 11 between ultrafine crystal grains 10, the cutting mode of the primary ultrafine-crystalline alloy ribbon 1 may be called “fracture mode.”

Because the primary ultrafine-crystalline alloy ribbon 1 uniformly pressed by the blade 2a of the cutter 2 should be sharply bent, the base 3 supporting the ribbon 1 should be soft enough to be deformed to an acute angle by local pressing. The bending angle θ of the primary ultrafine-crystalline alloy ribbon 1 is preferably 60° or more. With the bending angle θ of 60° or more, the primary ultrafine-crystalline alloy ribbon 1 is surely fracture-cut. Of course, to elevate the blade 2a of the cutter 2 for the next cutting operation, the base 3 should be returned to the original position. For this purpose, the base 3 is preferably soft with rubber elasticity. If the base 3 is too hard, the primary ultrafine-crystalline alloy ribbon 1 is not sharply bent but jaggedly broken by pushing the blade 2a of the cutter 2, failing to achieve straight cutting.

Though the base 3 can be formed by a single rubber or resin, a laminate comprising a sponge layer 3a and a rubber sheet 3b attached to an upper surface of the sponge layer 3a as shown in FIG. 1(a) is preferable to have sufficient softness and durability. The rubber sheet 3b is preferably a natural or synthetic rubber as thick as about 0.3-2 mm, particularly a fluororubber (vinylidene fluoride rubber, tetrafluoroethylene rubber, etc.) for excellent slidability. The sponge layer 3a is preferably a rubber or resin sponge, a polyurethane foam, etc. The thickness of the sponge layer 3a is determined such that the primary ultrafine-crystalline alloy ribbon 1 pressed by the cutter with the sponge deformed is sufficiently bent to an acute angle, so that it is fracture-cut. Specifically, the thickness of the sponge layer 3a may be about 2-30 mm.

Though not restrictive as long as a straight cut portion is obtained, the cutter 2 is preferably a metal-made cutter to keep its blade 2a straight. To apply uniform pressure to the primary ultrafine-crystalline alloy ribbon 1, a curve (deviation from a straight line) of the blade 2a of the cutter 2 over the entire length is preferably 100 μm or less. As long as the primary ultrafine-crystalline alloy ribbon 1 can be bent sharply, the blade 2a of the cutter 2 need not be as sharp as a knife edge, but may be something as sharp as a blade of a hand scraper made of stainless steel. Because a blade 2a of a not-so-sharp cutter 2 is resistant to wear and damage, such cutter 2 can be used for a long period of time, resulting in economic advantage.

When a blade 2a of a cutter 2 is pressed to a primary ultrafine-crystalline alloy ribbon 1 placed on a sufficiently soft base 3, pressure applied to the ribbon 1 is made substantially uniform by the deformation of the base 3, even though the entire blade 2a is not completely horizontal to a surface of the ribbon 1. However, to achieve the linearity of a cut portion surely, the blade 2a of the cutter 2 is preferably pressed to the primary ultrafine-crystalline alloy ribbon 1 as horizontally as possible.

(2) Hardness and its Distribution

In order that the primary ultrafine-crystalline alloy ribbon is cut along a straight line by a “fracture mode,” (a) ultrafine crystal grains having a desired average grain size should be dispersed at a desired ratio (% by volume) in an amorphous matrix, and (b) the dispersion of ultrafine crystal grains should be uniform in the primary ultrafine-crystalline alloy ribbon. However, because it is difficult to observe the dispersion of ultrafine crystal grains by a microscope every time, a method capable of easily detecting their dispersion at a production site is desired. Intensive research has revealed that the degree of precipitation of ultrafine crystal grains is so correlated with Vickers hardness Hv that (a) a primary ultrafine-crystalline alloy ribbon comprising ultrafine crystal grains with desired average grain size and volume fraction dispersed in an amorphous matrix has Vickers hardness Hv in a range of 850-1150, and that (b) when the primary ultrafine-crystalline alloy ribbon has an uneven distribution of Vickers hardness Hv in a transverse direction, it is difficult to fracture-cut the ribbon along a straight line. Because the Vickers hardness Hv can be measured easily at a production site, the inspection of the primary ultrafine-crystalline alloy ribbon by Vickers hardness Hv is an important feature of the present invention.

The Vickers hardness Hv of the primary ultrafine-crystalline alloy ribbon varies depending on ultrafine crystal grains precipitated in the amorphous matrix. The more ultrafine crystal grains precipitated, the larger Vickers hardness Hv the primary ultrafine-crystalline alloy ribbon has. Cu atoms oversaturated by liquid quenching are diffused and aggregated to form clusters (regular lattice of about several nanometers), which are used as nuclei for the precipitation of ultrafine crystal grains. The amount of ultrafine crystal grains precipitated tends to be affected by a cooling speed. A higher cooling speed makes the amorphous matrix stable before reaching the oversaturation, resulting in a low number density of ultrafine crystal grains, which provides the ribbon with hardness substantially not different from that of a usual amorphous matrix. On the other hand, a lower cooling speed increases the number density of ultrafine crystal grains, resulting in increased hardness.

It has been found that because the cooling capability of a cooling roll depends on a contact area with a melt and heat flux in the roll, there are more heat paths in side portions than in a center portion in the primary ultrafine-crystalline alloy ribbon, so that the side portions have higher cooling efficiency than the center portion, resulting in the side portions having a smaller number density of ultrafine crystal grains and thus lower hardness. Further, thickness difference in a transverse direction would lead to cooling speed difference, and thus the volume fraction difference of ultrafine crystal grains. Because a wide ribbon is likely subject to the unevenness of a cooling speed in a transverse direction, the thickness difference should be reduced. The thickness difference in a transverse direction also leads to a hardness distribution in a transverse direction. Because the hardness distribution in a transverse direction means ultrafine crystal grains differently dispersed in a transverse direction, and thus the propagation difference of cracks in a transverse direction, so that a straight cut portion cannot easily be obtained.

Intensive research in view of the above problems has revealed that a straight cut portion can be surely obtained when the primary ultrafine-crystalline alloy ribbon has Vickers hardness Hv in a range of 850-1150, with a Vickers hardness Hv distribution (difference between the maximum value and the minimum value) of 150 or less in a transverse direction. When the primary ultrafine-crystalline alloy ribbon has Vickers hardness Hv of less than 850 at any point, ultrafine crystal grains are insufficiently precipitated, providing a mixture of a fracture mode and a shear-cutting mode, and thus failing to obtain a straight cut portion. On the other hand, when the Vickers hardness Hv is more than 1150, too many ultrafine crystal grains are precipitated, resulting in too low toughness (too brittle). As a result, the cut portion tends to be jaggedly fractured, making it difficult to obtain a straight cut portion. Accordingly, to obtain a cut portion as straight as possible, the Vickers hardness Hv of the primary ultrafine-crystalline alloy ribbon in both center and side portions in a transverse direction should be in a range of 850-1150, and is preferably 850-1100, more preferably 850-1000, most preferably 850-900.

Further, the primary ultrafine-crystalline alloy ribbon should have a Vickers hardness Hv distribution (hardness difference between a center portion and side portions) of within 150 in a transverse direction. The term “the hardness difference between a center portion and side portions” means the difference between the maximum Vickers hardness Hv in a center portion and the minimum Vickers hardness Hv in side portions. When the Vickers hardness Hv distribution in a transverse direction is more than 150, a partially cut portion propagates meanderingly, failing to be straight. The Vickers hardness Hv distribution in a transverse direction is preferably 100 or less, more preferably 50 or less.

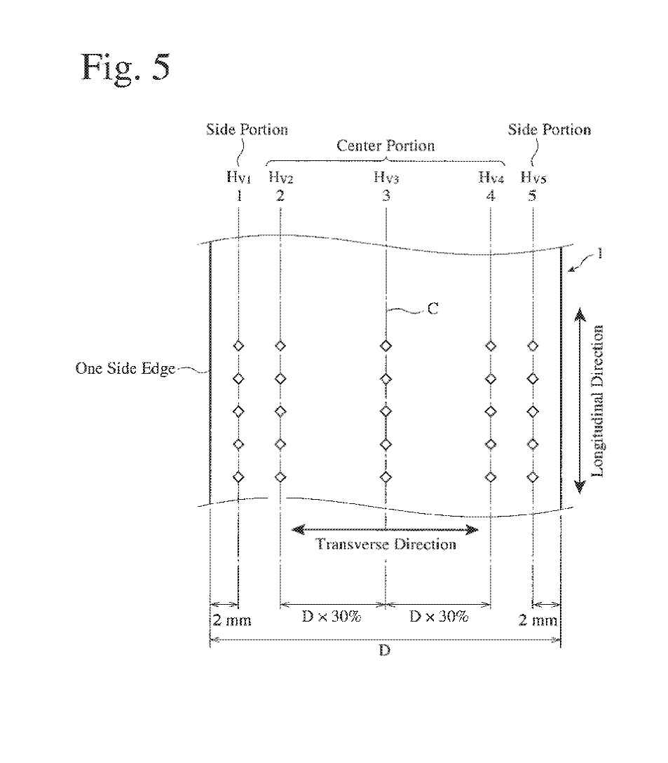

The Vickers hardness Hv of the primary ultrafine-crystalline alloy ribbon is determined by averaging hardness values measured under a load of 100 gf at pluralities of points in side and center portions. To eliminate measurement errors, the number of measurement at each point (the number of samples measured) is preferably 5 or more. It should be noted that as shown in FIG. 5, the Vickers hardness Hv in side portions is an average value of Vickers hardness values Hv₁ and Hv₅ measured at a position 2 mm from each side edge of the primary ultrafine-crystalline alloy ribbon 1, and the Vickers hardness Hv in a center portion is an average value of Vickers hardness values Hv₂, Hv₃ and Hv₄ measured at a position on a longitudinal centerline C of the primary ultrafine-crystalline alloy ribbon 1, and at positions separate from the centerline C by 30% of the entire width D in both transverse directions. It should be noted that measurement points and the number of measurement are not restricted thereto, but may be changed properly.

(3) Linearity of Cut Portion

The fracture-mode cutting cannot provide the primary ultrafine-crystalline alloy ribbon 1 with a completely straight cut portion 12, resulting in slight jaggedness as shown in FIG. 4. The jaggedness of the cut portion 12 is substantially provided by portions 14 generated by the detachment of cracks. Thus, the total area S of notches 14 is divided by the width D of the ribbon 1 to determine an average depth Dav of the notches 14, and the ratio of the notches 14 is determined from the average depth Dav and the ribbon width D by the following formula:

Ratio of notches=(Dav/D)×100(%).

To avoid an adverse effect on productivity, the ratio of the notches 14 should be 5% or less. The ratio of the notches 14 is preferably 3% or less.

Of course, even if the percentage of notches 14 were 5% or less, notches 14 with acute-angle corners, if any, would undesirably act as crack-starting sites in subsequent steps. Accordingly, it is preferable to evaluate the presence of acute-angle corners in the notches 14. The acute-angle corner is (a) a corner at which two straight lines cross at an angle of 90° or less, or (b) a curved corner having a radius of curvature of 1 mm or less. When the percentage of notches 14 is 5% or less without acute-angle corners, it may be said that the cut portion 12 of the primary ultrafine-crystalline alloy ribbon 1 has good linearity.

(3) Thickness Distribution

In the evaluation of the magnetic properties (particularly magnetic flux density) of the alloy ribbon, the thickness distribution (difference) in a transverse direction leads to the above hardness distribution. In addition, the thickness distribution in a transverse direction makes it difficult to measure the cross section area of the alloy ribbon accurately, and reduces a space factor when laminated. Accordingly, the alloy ribbon should have as small thickness distribution as possible in a transverse direction. The thickness distribution is a factor causing the above hardness distribution.

It has been found that to reduce the thickness distribution in a transverse direction in the primary ultrafine-crystalline alloy ribbon, the control of a gap between a nozzle and a cooling roll during casting is effective. Too wide a gap between the nozzle and the roll provides an alloy ribbon thicker in a center portion than in side portions. The thickness difference of the ribbon leads to a cooling speed difference, resulting in difference in the density of ultrafine crystal grains, which generates hardness distribution in a transverse direction. Specifically, in the case of casting an alloy ribbon of 10 mm or more in width and 15 μm or more in thickness, a gap of 300 μm or less between the nozzle and the cooling roll provides thickness distribution of 2 μm or less in a transverse direction, suppressing hardness difference in a transverse direction. To reduce the thickness distribution in a transverse direction, the gap between the nozzle and the cooling roll is preferably 150-250 μm, more preferably 180-230 μm.

(4) Shape of Cut Cross Section

A cut cross section of the primary ultrafine-crystalline alloy ribbon formed by the linear pressing method of the present invention is free from traces of cutting with a cutter blade and plastic deformation, indicating that it is cut by fracture due to the propagation of cracks. The linear pressing method provides a primary ultrafine-crystalline alloy ribbon having relatively low Vickers hardness Hv with a cut cross section which is plastically deformed by the cutter blade partially in a transverse direction, but most of the cut cross section is formed by a fracture mode due to the propagation of cracks. On the other hand, a cut cross section formed by scissors in an amorphous alloy ribbon has vertical streaks, indicating that the amorphous alloy ribbon is cut by the shear-cutting mode.

### [2] Nanocrystalline, Soft Magnetic Alloy Ribbon

The heat treatment of each piece obtained by cutting the primary ultrafine-crystalline alloy ribbon by the fracture mode provides a nanocrystalline, soft magnetic alloy ribbon piece. The nanocrystalline, soft magnetic alloy ribbon holds the characteristics of the primary ultrafine-crystalline alloy ribbon per se. Notches along the cut portion are also 5% or less in the nanocrystalline, soft magnetic alloy ribbon. The percentage of notches is preferably 3% or less. The cut portion is preferably free from acute-angle corners.

### [3] Production Method of Primary Ultrafine-Crystalline Alloy Ribbon

(1) Alloy Melt

The alloy melt has a composition represented by Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions of 0<x≦5, 10≦y≦22, 0≦z≦10, and x+y+z≦25, respectively, when expressed by atomic %. Taking the use of Cu as the element A for example, the production method will be explained in detail below.

(2) Quenching of Melt

The alloy melt can be quenched by a single roll method. The melt temperature is preferably higher than the melting point of the alloy by 50-300° C. In the case of producing a ribbon of several tens of micronmeters in thickness in which ultrafine crystal grains are precipitated, for example, a melt at about 1300-1400° C. is preferably ejected from a nozzle onto a cooling roll. The atmosphere in the single roll method is air or an inert gas (Ar, nitrogen, etc.) when the alloy does not contain an active metal, and an inert gas (Ar, He, nitrogen, etc.) or vacuum when the alloy contains an active metal. To form an oxide layer on the surface, the melt is quenched preferably in an oxygen-containing atmosphere (for example, in the air).

The formation of ultrafine crystal grains is closely related with the cooling speed and time of the alloy ribbon, and it is important to control the volume fraction of ultrafine crystal grains. One of means for controlling the volume fraction of ultrafine crystal grains is to control the peripheral speed of the cooling roll. A higher peripheral speed of the roll provides a smaller volume fraction of ultrafine crystal grains, and a lower peripheral speed provides a larger volume fraction. The peripheral speed of the roll is preferably 15-50 m/s, more preferably 20-40 m/s, most preferably 25-35 m/s.

Materials for the roll are suitably pure copper or copper alloys such as Cu—Be, Cu—Cr, Cu—Zr, Cu—Zr—Cr, etc. having high thermal conductivity. In the case of mass production, or in the case of producing a thick and/or wide ribbon, the roll is preferably cooled by water. Because the water-cooling of the roll affects the volume fraction of ultrafine crystal grains, it is effective to keep the cooling capability, which may be called cooling speed, of the roll. Because the cooling capability of the roll is correlated with the temperature of cooling water in a mass production line, it is effective to keep the cooling water at a predetermined temperature or higher.

(3) Adjustment of Gap

In a single roll method for casting an alloy melt ejected onto a cooling roll rotating at a high speed, the melt is not solidified on the roll immediately after ejection but keeps a liquid state for about 10⁻⁸ to 10⁻⁶ seconds. A melt in this state is called “paddle.” Controlling the paddle makes it possible to adjust the thickness, cross section shape, surface undulation, etc. of the ribbon. The paddle can be controlled by adjusting a gap between the nozzle and the cooling roll, a melt-ejecting pressure, the weight of the melt, etc. Among them, the melt-ejecting pressure and the weight of the melt cannot be easily adjusted, because they are variable depending on the amount of a remaining melt, a melt temperature, etc. On the other hand, the gap can easily be controlled by always feedbacking the monitored distance between the nozzle and the cooling roll. It is thus preferable to adjust the thickness, cross section shape, surface undulation, etc. of the primary ultrafine-crystalline alloy ribbon by controlling the gap.

In general, a wider gap provides a better flow of the melt, effective for producing a thicker primary ultrafine-crystalline alloy ribbon and preventing the collapse of a paddle. However, too wide a gap provides the ribbon with a cross section shape having a thick center portion and thin side portions, resulting in cooling speed difference due to the thickness difference, which leads to difference in the amount of ultrafine crystal grains precipitated, and thus hardness difference. To suppress the thickness difference to 2 μm or less in transverse direction to have reduced hardness difference, the gap should be 300 μm or less. The gap is preferably 250 μm or less, more preferably 200 μm or less. By narrowing the gap or changing the nozzle slit shape to obtain a cross section shape thicker in side portions than in a center portion in a transverse direction, the cooling speed difference in a transverse direction is reduced, resulting in reduced hardness distribution in a transverse direction. Though a narrower gap reduces the thickness difference of the ribbon, it poses the problem of easy collapse of a paddle. From the aspect of productivity, the lower limit of the gap is preferably 100 μm. Because a smaller slit width in a center portion results in more clogging of the melt, a ratio of the slit width in side portions to that in a center portion is desirably 2 times or less.

(4) Peeling Temperature

With an inert gas (nitrogen, etc.) blown from a nozzle to a space between the primary ultrafine-crystalline alloy ribbon obtained by quenching and the cooling roll, the primary ultrafine-crystalline alloy ribbon is stripped from the cooling roll. The stripping temperature of the primary ultrafine-crystalline alloy ribbon (correlated with the cooling time) also affects the volume fraction of ultrafine crystal grains. The stripping temperature of the primary ultrafine-crystalline alloy ribbon, which can be adjusted by changing the position of a nozzle ejecting an inert gas (stripping position), is generally 170-350° C., preferably 200-340° C., more preferably 250-330° C. When the stripping temperature is lower than 170° C., excessive quenching occurs, resulting in a substantially amorphous alloy structure. On the other hand, when the stripping temperature is higher than 350° C., crystallization by Cu proceeds excessively, resulting in a brittle ribbon. With a proper cooling speed, a surface portion of the ribbon is subject to relatively rapid cooling to reduce the amount of Cu, so that ultrafine crystal grains are not formed, while an inner portion of the ribbon is subject to relatively slow cooling to precipitate many ultrafine crystal grains.

Because the inner portion of the stripped primary ultrafine-crystalline alloy ribbon is still at a relatively high temperature, the primary ultrafine-crystalline alloy ribbon is sufficiently cooled before winding to prevent further crystallization. For example, an inert gas (nitrogen, etc.) is blown to the stripped primary ultrafine-crystalline alloy ribbon to cool it to substantially room temperature, and then the ribbon is wound.

### [4] Nanocrystalline, Soft Magnetic Alloy Ribbon

The heat treatment of the primary ultrafine-crystalline alloy ribbon provides a nanocrystalline, soft magnetic alloy ribbon having a structure in which fine crystal grains with a body-centered cubic (bcc) structure having an average grain size of 60 nm or less are dispersed at a volume fraction of 30% or more, preferably 50% or more, in an amorphous phase. The average grain size of fine crystal grains is of course larger than that of ultrafine crystal grains before the heat treatment, preferably 15-40 nm. Because it has already been confirmed by measuring Vickers hardness Hv at a stage of the primary ultrafine-crystalline alloy ribbon whether or not desired soft magnetic properties can be achieved, as described above, it is surely expected that the nanocrystalline, soft magnetic alloy ribbon obtained by the heat treatment also has excellent soft magnetic properties.

(1) Heat Treatment Method

(a) High-Temperature, Short-Time Heat Treatment

One mode of heat treatments applied to the primary ultrafine-crystalline alloy ribbon of the present invention is a high-temperature, high-speed heat treatment, in which the primary ultrafine-crystalline alloy ribbon is heated to the highest temperature at a temperature-elevating speed of 100° C./minute or more, and kept at the highest temperature for 1 hour or less. An average temperature-elevating speed up to the highest temperature is preferably 100° C./minute or more. Because the temperature-elevating speed in a high-temperature range of 300° C. or higher has large influence on the magnetic properties, the average temperature-elevating speed in a temperature range of 300° C. or higher is preferably 100° C./minute or more. The highest temperature in the heat treatment is preferably (Tₓ₂−50)° C. or higher, wherein Tₓ₂ is a precipitation temperature of compounds, specifically 430° C. or higher. When it is lower than 430° C., the precipitation and growth of fine crystal grains are insufficient. The upper limit of the highest temperature is preferably 500° C. (Tₓ₂) or lower. Even if a time period of keeping the highest temperature were more than 1 hour, fine crystallization would not change drastically, resulting in only low productivity. The keeping time is preferably 30 minutes or less, more preferably 20 minutes or less, most preferably 15 minutes or less. Even with such high-temperature heat treatment, the growth of crystal grains and the formation of compounds would be able to be suppressed as long as the keeping time is short, resulting in small coercivity, an improved magnetic flux density in a low magnetic field, and reduced hysteresis loss.

(b) Low-Temperature, Long-Time Heat Treatment

Another mode of heat treatments is a low-temperature, low-speed heat treatment, in which the primary ultrafine-crystalline alloy ribbon is kept at the highest temperature of about 350° C. or higher and lower than 430° C. for 1 hour or more. From the aspect of mass productivity, the keeping time is preferably 24 hours or less, more preferably 4 hours or less. To suppress increase in coercivity, the average temperature-elevating speed is preferably 0.1-200° C./minute, more preferably 0.1-100° C./minute. This heat treatment provides a nanocrystalline, soft magnetic alloy ribbon with a high squareness ratio.

(c) Heat Treatment Atmosphere

Though the heat treatment atmosphere may be air, it has an oxygen concentration of preferably 6-18%, more preferably 8-15%, most preferably 9-13%, to form an oxide layer having a desired layer structure by the diffusion of Si, Fe, B and Cu toward the surface. The heat treatment atmosphere is preferably a mixed gas of an inert gas such as nitrogen, Ar, helium, etc. with oxygen. The dew point of the heat treatment atmosphere is preferably −30° C. or lower, more preferably −60° C. or lower.

(d) Heat Treatment in a Magnetic Field

To impart good induction magnetic anisotropy to the nanocrystalline, soft magnetic alloy ribbon by a heat treatment in a magnetic field, a magnetic field having sufficient intensity to saturate the soft magnetic alloy is preferably applied, in any case of (1) while the heat treatment temperature is 200° C. or higher (preferably 20 minutes or more), (2) during the temperature elevation, (3) while the highest temperature is kept, or (4) during cooling. Though variable depending on the shape of the alloy ribbon, the magnetic field intensity is preferably 8 kA/m or more in any case where it is applied in a transverse direction of the ribbon (a height direction in a toroidal core) or in a longitudinal direction of the ribbon (a circumferential direction in a toroidal core). The magnetic field may be a DC magnetic field, an AC magnetic field, or a pulse magnetic field. The heat treatment in a magnetic field provides the nanocrystalline, soft magnetic alloy ribbon with a DC hysteresis loop having high or low squareness. A heat treatment with no magnetic field provides the nanocrystalline, soft magnetic alloy ribbon with a DC hysteresis loop having intermediate squareness.

(2) Surface Treatment

The nanocrystalline, soft magnetic alloy ribbon may be provided with an oxide coating such as SiO₂, MgO, Al₂O₃, etc., if necessary. A surface treatment during a heat treatment step provides high oxide bonding. Cores formed by the nanocrystalline, soft magnetic alloy ribbon may be impregnated with resins, if necessary.

(3) Matrix Structure of Nanocrystalline, Soft Magnetic Alloy Ribbon

The amorphous matrix obtained by the heat treatment has a structure in which fine crystal grains with a body-centered cubic (bcc) structure having an average grain size of 60 nm or less are dispersed at a volume fraction of 30% or more in an amorphous phase. When the average grain size of fine crystal grains exceeds 60 nm, the ribbon has deteriorated soft magnetic properties. When the volume fraction of fine crystal grains is less than 30%, the ratio of the amorphous phase is too large, resulting in a low saturation magnetic flux density. The average grain size of fine crystal grains after the heat treatment is preferably 40 nm or less, more preferably 30 nm or less. The lower limit of the average grain size of fine crystal grains is generally 12 nm, preferably 15 nm, more preferably 18 nm. The volume fraction of fine crystal grains after the heat treatment is preferably 50% or more, more preferably 60% or more. With the average grain size of 60 nm or less and the volume fraction of 30% or more, an alloy ribbon having excellent soft magnetic properties and lower magnetostriction than that of an Fe-based amorphous alloy is obtained. Though an Fe-based amorphous alloy ribbon having the same composition has relatively large magnetostriction due to a magnetic volume effect, the nanocrystalline, soft magnetic alloy ribbon in which bcc-Fe-based, fine crystal grains are dispersed has much smaller magnetostriction due to the magnetic volume effect, exhibiting a larger noise-reducing effect.

### [5] Magnetic Devices

Because magnetic devices formed by the nanocrystalline, soft magnetic alloy ribbon have high saturation magnetic flux densities, they are suitable for high-power applications in which high magnetic saturation is important, for example, large-current reactors such as anode reactors; choke coils for active filters; smoothing choke coils; magnetic pulse power devices used in laser power supplies, accelerators, etc.; magnetic cores for transformers, communications pulse transformers, motors and power generators; yokes; current sensors; magnetic sensors; antenna cores; electromagnetic-wave-absorbing sheets, etc. Pluralities of the alloy ribbons may be laminated, and the resultant laminates are further laminated to provide wound cores for transformers.

The present invention will be explained in more detail referring to Examples below without intention of restricting the present invention thereto. In each Example and Comparative Example, the stripping temperature, the average grain size and volume fraction of fine crystal grains, the Vickers hardness Hv, the cutting mode, and the percentage of notches were measured by the following methods.

(1) Measurement of Stripping Temperature

The temperature of a primary ultrafine-crystalline alloy ribbon when stripped from a cooling roll by a nitrogen gas blown from a nozzle was measured by a radiation thermometer (FSV-7000E available from Apiste), and regarded as a stripping temperature.

(2) Measurement of Average Grain Size and Volume Fraction of Ultrafine Crystal Grains

The average grain size of ultrafine crystal grains was determined by measuring the long diameters D_{L} and short diameters D_{S} of ultrafine crystal grains in the number of n (30 or more) arbitrarily selected from a TEM photograph of each sample, and averaging them by the formula of Σ(D_{L}+D_{S})/2n. An arbitrary straight line having a length Lt was drawn on a TEM photograph of each sample, to determine the total length Lc of portions of each straight line which crossed ultrafine crystal grains, thereby calculating a ratio (L_{L}=Lc/Lt) of ultrafine crystal grains along each straight line. Repeating this operation 5 times to average the L_{L}, the volume fraction of ultrafine crystal grains was determined. The volume fraction V_{L}=Vc/Vt, wherein Vc is a total volume of ultrafine crystal grains, and Vt is a volume of a sample, was approximated to V_{L}≈Lc³/Lt³=L_{L}³.

(3) Measurement of Vickers Hardness Hv

As shown in FIG. 5, a sample of each primary ultrafine-crystalline alloy ribbon 1 was provided with measurement points of 5×5 in transverse and longitudinal directions, such that lines 1 to 5 each having five measurement points extended in a longitudinal direction. Measurement point lines 1, 5 in side portions were positioned 2 mm from each side edge, and measurement point lines 2, 3, 4 in a center portion were positioned along the centerline C, and along lines separated by 30% of the entire width D from the centerline C in a transverse direction. The Vickers hardness Hv of a sample at each measurement point was measured at a load of 100 g, using a micro-Vickers hardness meter (Model-MVK Type C7 available from Mitutoyo Corporation).

With an average value of Vickers hardness Hv in each measurement point line 1 to 5 being Hv₁, Hv₂, Hv₃, Hv₄ and Hv₅, respectively, an average value of Hv₁ and Hv₅ was regarded as the Vickers hardness Hv in side portions, an average value of Hv₂ to Hv₄ was regarded as the Vickers hardness Hv in a center portion, an average value of Hv₁ to Hv₅ was regarded as the Vickers hardness Hv of the entire alloy ribbon, and the difference between the maximum value among Hv₂ to Hv₄ and the minimum value of Hv₁ and Hv₅ was regarded as Vickers hardness Hv difference in center and side portions.

(4) Determination of Cutting Mode

In the cutting of a sample of each primary ultrafine-crystalline alloy ribbon by scissors in a transverse direction, it was judged as “shear-cutting mode,” when cutting was able to be conducted along a straight line without notches of 1 mm or more. Next, a sample provided with notches of 1 mm or more was fracture-cut by the linear pressing method shown in FIG. 1 in a transverse direction, to evaluate the linearity of a cut portion (percentage of notches). As shown in FIG. 4, the total area S of notches 14 such as jagged breakage, etc. generated along a cut portion 12 of the primary ultrafine-crystalline alloy ribbon 1 was divided by the width D of the ribbon 1 to determine the average depth Dav of notches 14, and the percentage of notches in the cut portion was determined from the average depth Dav and the width D of the ribbon by the following formula:

Percentage of notches=(Dav/D)×100(%).

When the percentage of notches was 5% or less, the linearity of a cut portion was determined as good.

### Examples 1 to 8

By a single roll method using a cooling roll made of a copper alloy, each alloy melt (1300° C.) having the composition shown in Table 1 was quenched in the air, and stripped from the roll at a ribbon temperature of 250° C. to obtain a primary ultrafine-crystalline alloy ribbon of 25 mm (Examples 1 to 5) and 50 mm (Examples 6 to 8) in width. To adjust the average grain size and volume fraction of ultrafine crystal grains, and the Vickers hardness Hv of the primary ultrafine-crystalline alloy ribbon, a gap between a nozzle and the cooling roll and a the peripheral speed of the roll (27-36 m/s) were changed during casting as shown in Table 1.

As shown in FIG. 5, the thickness and Vickers hardness Hv of each primary ultrafine-crystalline alloy ribbon were measured in each measurement point line 1 to 5. The average thickness was obtained by averaging the thickness values measured in the measurement point lines 1 to 5, and the thickness difference was difference between the maximum value and the minimum value among the thickness values measured in the measurement point lines 1 to 5. The average grain size and volume fraction of ultrafine crystal grains in each primary ultrafine-crystalline alloy ribbon were also measured. The results are shown in Table 1. The Vickers hardness Hv in a center portion is an average value of Hv₂, Hv₃ and Hv₄; the Vickers hardness Hv in side portions is an average value of Hv₁ and Hv₅; the hardness difference is difference between the maximum value among Hv₂, Hv₃ and Hv₄ in a center portion, and the minimum value of Hv₁ and Hv₅ in side portions; and the Vickers hardness Hv of the entire ribbon is an average value of Hv₁, Hv₂, Hv₃, Hv₄ and Hv₅.

In the cutting of each primary ultrafine-crystalline alloy ribbon by scissors (shear cutting), a case where cutting was conducted along a straight line was called “cut,” and a case where cracking or fracturing occurred was called “broken.” With respect to each cracked or fractured primary ultrafine-crystalline alloy ribbon, cutting by the linear pressing method shown in FIG. 1 was tried to examine whether or not cutting (fracture-cutting) was able to be conducted by a fracture mode, and the linearity of a cut portion (percentage of notches) was measured. The results are shown in Table 1.

### Comparative Examples 1 to 9

Each alloy melt having the composition shown in Table 1 was quenched in the air under the same conditions as in Examples 1 to 8, to produce a primary ultrafine-crystalline alloy ribbon (Comparative Examples 1 to 6 and 9) and an amorphous alloy ribbon (Comparative Examples 7 and 8) having a width of 25 mm (Comparative Examples 1 to 6) and 50 mm (Comparative Examples 7 to 9). The thickness and Vickers hardness Hv of each primary ultrafine-crystalline alloy ribbon in each measurement point line 1 to 5, and the average grain size and volume fraction of ultrafine crystal grains in each alloy ribbon, were measured in the same manner as in Examples 1 to 8. Further, cutting was conducted by the shear cutting method and the linear pressing method to evaluate the linearity of a cut portion (percentage of notches). The results are shown in Table 1.

TABLE 1

Production Conditions

| | Composition | Gap | Peripheral Speed |
|---|---|---|---|
| No.⁽¹⁾ | (atomic %) | (μm) | (m/s) |
| Example 1 | Fe_{bal.}Ni₁Cu_{1.4}Si₄B₁₄ | 300 | 36 |
| Example 2 | Fe_{bal.}Ni₁Cu_{1.4}Si₄B₁₄ | 270 | 34 |
| Example 3 | Fe_{bal.}Ni₁Cu_{1.4}Si₄B₁₄ | 250 | 31 |
| Example 4 | Fe_{bal.}Ni₁Cu_{1.4}Si₄B₁₄ | 210 | 28 |
| Example 5 | Fe_{bal.}Ni₁Cu_{1.4}Si₄B₁₄ | 210 | 27 |
| Com. Ex. 1 | Fe_{bal.}Ni₁Cu_{1.4}Si₄B₁₄ | 180 | 27 |
| Com. Ex. 2 | Fe_{bal.}Ni₁Cu_{1.4}Si₄B₁₄ | 160 | 27 |
| Com. Ex. 3 | Fe_{bal.}Ni₁Cu_{1.4}Si₄B₁₄ | 150 | 27 |
| Com. Ex. 4 | Fe_{bal.}Ni₁Cu_{1.4}Si₄B₁₄ | 150 | 30 |
| Com. Ex. 5 | Fe_{bal.}Ni₁Cu_{1.4}Si₄B₁₄ | 140 | 27 |
| Com. Ex. 6 | Fe_{bal.}Ni₁Cu_{1.4}Si₄B₁₄ | 320 | 30 |
| Com. Ex. 7 | Fe_{bal.}Si₄B₁₄ | 180 | 23 |
| Com. Ex. 8 | Fe_{bal.}Nb₃Cu₁Si₁₄B₈ | 180 | 27 |
| Example 6 | Fe_{bal.}Cu_{1.4}Si₅B₁₃ | 250 | 32 |
| Example 7 | Fe_{bal.}Cu_{1.4}Si₆B₁₃ | 300 | 35 |
| Com. Ex. 9 | Fe_{bal.}Cu_{1.4}Si₆B₁₃ | 310 | 35 |
| Example 8 | Fe_{bal.}Cu_{1.6}Si₅B₁₃ | 180 | 35 |

| | | |
|---|---|---|
| Average | Thickness | Ultrafine Crystal Grains |

| | Thickness | Difference | Average Grain | Amount |
|---|---|---|---|---|
| No.⁽¹⁾ | (μm) | (μm) | Size (nm) | (% by volume) |
| Example 1 | 23.2 | 1.9 | 20 | 30 |
| Example 2 | 22.8 | 1.4 | 15 | 25 |
| Example 3 | 21.1 | 1.0 | 10 | 20 |
| Example 4 | 21.3 | 0.5 | 10 | 15 |
| Example 5 | 21.3 | 0.7 | 5 | 5 |
| Com. Ex. 1 | 19.9 | 0.5 | 3 | 3 |
| Com. Ex. 2 | 19.0 | 0.5 | 3 | 3 |
| Com. Ex. 3 | 18.3 | 0.7 | 3 | 1 |
| Com. Ex. 4 | 17.9 | 0.5 | 3 | 1 |
| Com. Ex. 5 | 18.5 | 0.6 | 3 | 1 |
| Com. Ex. 6 | 24.6 | 2.5 | 25 | 35 |
| Com. Ex. 7 | 24.0 | 0.7 | — | 0 |
| Com. Ex. 8 | 20.2 | 0.5 | — | 0 |
| Example 6 | 23.2 | 1.0 | 15 | 20 |
| Example 7 | 23.8 | 1.8 | 15 | 25 |
| Com. Ex. 9 | 24.6 | 2.1 | 20 | 30 |
| Example 8 | 15.1 | 0.4 | 15 | 25 |

| | | | | | | Linear Cutting | |
|---|---|---|---|---|---|---|---|
| | Vickers hardness (Hv) | | | | | Method | |
| | In Center | In Side | Hardness | In Entire | Shear- | Fracture | Notches |
| No.⁽¹⁾ | Portion | Portions | Difference | Ribbon | Cutting | Mode | (%) |
| Example 1 | 1024 | 881 | 147 | 967 | Broken | Entirely | 4.5 |
| Example 2 | 960 | 866 | 94 | 953 | Broken | Entirely | 1.0 |
| Example 3 | 910 | 864 | 59 | 891 | Broken | Entirely | 0.5 |
| Example 4 | 890 | 857 | 37 | 877 | Broken | Entirely | 0.3 |
| Example 5 | 889 | 859 | 32 | 877 | Broken | Entirely | 0.2 |
| Com. Ex. 1 | 833 | 812 | 21 | 825 | Broken | Partially | — |
| Com. Ex. 2 | 833 | 805 | 30 | 827 | Broken | Partially | — |
| Com. Ex. 3 | 808 | 779 | 47 | 796 | Broken | Partially | — |
| Com. Ex. 4 | 805 | 788 | 20 | 800 | Broken | Partially | — |
| Com. Ex. 5 | 770 | 742 | 28 | 760 | Broken | Partially | — |
| Com. Ex. 6 | 1127 | 928 | 208 | 1047 | Broken | Entirely | 8.0 |
| Com. Ex. 7 | 802 | 800 | 5 | 801 | Cut | No | — |
| Com. Ex. 8 | 755 | 743 | 12 | 750 | Cut | No | — |
| Example 6 | 942 | 910 | 52 | 929 | Broken | Entirely | 2.0 |
| Example 7 | 965 | 936 | 38 | 953 | Broken | Entirely | 4.5 |
| Com. Ex. 9 | 1051 | 961 | 191 | 1015 | Broken | Entirely | 5.5 |
| Example 8 | 1012 | 942 | 70 | 980 | Broken | Entirely | 4.2 |

Note:
⁽¹⁾“Com. Ex.” means “Comparative Example.”

In Example 1, the gap between the nozzle and the cooling roll was 300 μm, and the peripheral speed of the roll was 36 m/s, during casting. Vickers hardnesses Hv₁, Hv₂, Hv₃, Hv₄ and Hv₅ and thickness were measured at positions 2 mm (measurement point line 1), 5 mm (measurement point line 2), 12.5 mm (measurement point line 3), 20 mm (measurement point line 4), and 23 mm (measurement point line 5), respectively, from one side edge of the primary ultrafine-crystalline alloy ribbon. The results are shown in Table 2.

The Vickers hardness Hv (average value of Hv₂, Hv₃ and Hv₄) in a center portion was 1024, and the Vickers hardness Hv (average value of Hv₁ and Hv₅) in side portions was 881 (see Table 1), both within a range of 850-1150. Also, the hardness difference in a transverse direction (difference between the maximum Vickers hardness Hv₄ of 1027 in a center portion and the minimum Vickers hardness Hv₁ of 880 in side portions) was 147, meeting the requirement of 150 or less (see Table 1). There was hardness difference in a transverse direction, because fewer ultrafine crystal grains were precipitated in side portions due to the cooling speed difference. The thickness difference in a transverse direction was as small as 24.0−22.1=1.9 μm.

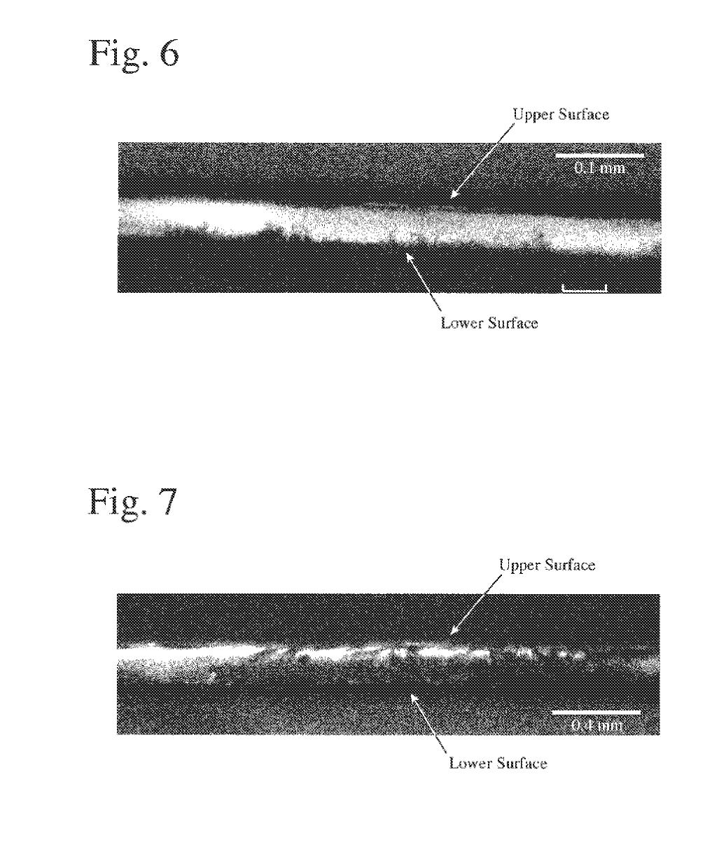

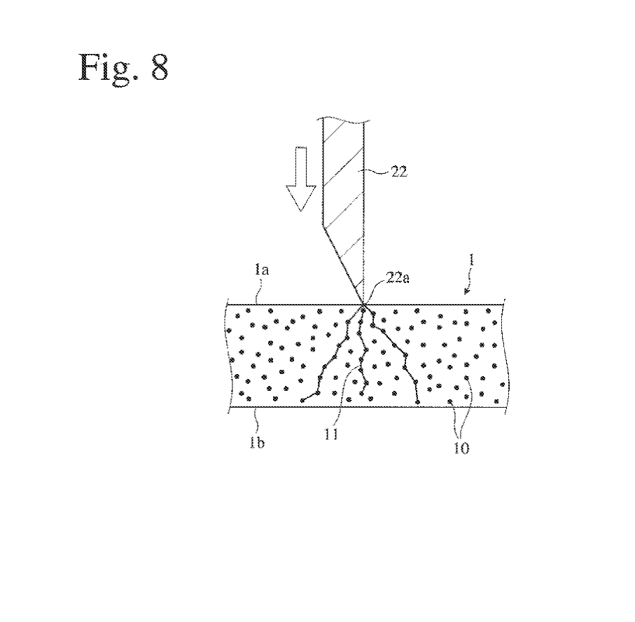

Though the shear cutting of the primary ultrafine-crystalline alloy ribbon of Example 1 by scissors suffered cracking and fracturing, labeled as “broken,” the primary ultrafine-crystalline alloy ribbon was fracture-cut by the linear pressing method of the present invention substantially along a straight line (fracture mode), with the percentage of notches as low as 4.5%. It is considered that because the thickness difference in a transverse direction was as small as 1.9 mm, ultrafine crystal grains are uniformly dispersed in a transverse direction, thereby suppressing notches. The primary ultrafine-crystalline alloy ribbon of Example 1 having relatively high Vickers hardness Hv was cut by the linear pressing method, and a photomicrograph showing a fracture-cut cross section thereof is shown in FIG. 6. A substantially entire cross section of the cut portion had a brittly fractured surface, and notches were observed along the fracture-cut cross section, though they were not deep.

TABLE 2

| | Example 1 | | |
|---|---|---|---|
| Measurement | Distance from One | Vickers Hardness | Thickness |
| Point Line | Side Edge (mm) | (Hv) | (μm) |
| 1 | 2 | Hv₁ 880 | 22.1 |
| 2 | 5 | Hv₂ 1024 | 23.9 |
| 3 | 12.5 | Hv₃ 1020 | 23.8 |
| 4 | 20 | Hv₄ 1027 | 24.0 |
| 5 | 23 | Hv₅ 882 | 22.2 |

In Example 3, the gap between the nozzle and the cooling roll was 250 μm, and the peripheral speed of the roll was 31 m/s, during casting. The Vickers hardness and thickness of the primary ultrafine-crystalline alloy ribbon measured in each measurement point line 1 to 5 in the same manner as in Example 1 are shown in Table 3. The Vickers hardness Hv in a center portion was 910, and the Vickers hardness Hv in side portions was 864, both within a range of 850-1150. The hardness difference in a transverse direction was 920−861=59, and the thickness difference in a transverse direction was as small as 21.7−20.7=1 μm. The primary ultrafine-crystalline alloy ribbon was fracture-cut by the linear pressing method of the present invention substantially along a straight line (fracture mode), with the percentage of notches as low as 0.5%.

In Example 2, the gap between the nozzle and the cooling roll was 270 μm, and the peripheral speed of the roll was 34 m/s, during casting. The resultant primary ultrafine-crystalline alloy ribbon had immediate Vickers hardness between Example 1 and Example 3, and fracture-cut by the linear pressing method of the present invention substantially along a straight line (fracture mode), with the percentage of notches as low as 1.0%.

TABLE 3

| | Example 3 | | |
|---|---|---|---|
| Measurement | Distance from One | Vickers Hardness | Thickness |
| Point Line | Side Edge (mm) | (Hv) | (μm) |
| 1 | 2 | Hv₁ 861 | 20.7 |
| 2 | 5 | Hv₂ 920 | 21.2 |
| 3 | 12.5 | Hv₃ 909 | 21.7 |
| 4 | 20 | Hv₄ 900 | 21.4 |
| 5 | 23 | Hv₅ 866 | 20.7 |

In Example 4, the gap between the nozzle and the cooling roll was 210 μm, and the peripheral speed of the roll was 28 m/s, during casting. The Vickers hardness and thickness of the primary ultrafine-crystalline alloy ribbon measured in each measurement point line 1 to 5 in the same manner as in Example 1 are shown in Table 4. The alloy ribbon had Vickers hardness Hv within a range of 850-1150 in both center and side portions. The hardness difference in a transverse direction was 892−855=37, and the thickness difference in a transverse direction was as small as 21.5−21.0=0.5 μm. The primary ultrafine-crystalline alloy ribbon was fracture-cut by the linear pressing method of the present invention substantially along a straight line (fracture mode), with the percentage of notches as low as 0.3%. The primary ultrafine-crystalline alloy ribbon of Example 4 having relatively low Vickers hardness Hv was cut by the linear pressing method, and a photomicrograph showing a fracture-cut cross section thereof is shown in FIG. 7. Regions plastically deformed by pressing a cutter blade were observed in an upper portion of the fracture-cut cross section, and a cross section brittly fractured by the propagation of cracks (fracture-mode cross section) was observed thereunder. Though plastically deformed regions existed in the case of relatively low Vickers hardness Hv, cutting was a fracture mode as a whole, with little notches by cracking.

TABLE 4

| | Example 4 | | |
|---|---|---|---|
| Measurement | Distance from One | Vickers Hardness | Thickness |
| Point Line | Side Edge (mm) | (Hv) | (μm) |
| 1 | 2 | Hv₁ 858 | 21.0 |
| 2 | 5 | Hv₂ 890 | 21.5 |
| 3 | 12.5 | Hv₃ 892 | 21.5 |
| 4 | 20 | Hv₄ 888 | 21.5 |
| 5 | 23 | Hv₅ 855 | 21.1 |

In Example 5, the gap between the nozzle and the cooling roll was 210 μm, and the peripheral speed of the roll was 27 m/s, during casting. The Vickers hardness and thickness of the primary ultrafine-crystalline alloy ribbon measured in each measurement point line 1 to 5 in the same manner as in Example 1 are shown in Table 5. The alloy ribbon had Vickers hardness Hv within a range of 850-1150 in both center and side portions. Though the thickness difference in a transverse direction was as small as 21.7−21.0=0.7 μm, the side portions were thicker than the center portion in this Example. This appears to be due to the fact that such a force as to push a center portion of the paddle was applied. The hardness difference in a transverse direction was 32, substantially the same as in Example 4. The primary ultrafine-crystalline alloy ribbon was fracture-cut by the linear pressing method of the present invention substantially along a straight line (fracture mode), with the percentage of notches as low as 0.2%.

TABLE 5

| | Example 5 | | |
|---|---|---|---|
| Measurement | Distance from One | Vickers Hardness | Thickness |
| Point Line | Side Edge (mm) | (Hv) | (μm) |
| 1 | 2 | Hv₁ 860 | 21.7 |
| 2 | 5 | Hv₂ 890 | 21.3 |
| 3 | 12.5 | Hv₃ 890 | 21.0 |
| 4 | 20 | Hv₄ 888 | 21.1 |
| 5 | 23 | Hv₅ 858 | 21.5 |

As described above, the primary ultrafine-crystalline alloy ribbons of Examples 1 to 5 can be cut in a “fracture mode” by the linear pressing method, providing cut portions with excellent linearity.

In Comparative Example 3, the gap between the nozzle and the cooling roll was 150 μm, and the peripheral speed of the roll was 27 m/s, during casting. The Vickers hardness and thickness of the primary ultrafine-crystalline alloy ribbon measured in each measurement point line 1 to 5 in the same manner as in Example 1 are shown in Table 6. The alloy ribbon had Vickers hardness Hv of less than 850 in both center and side portions, and particularly the Vickers hardness Hv in side portions was extremely low. Though the thickness difference was as small as 18.8−18.1=0.7 μm, the hardness difference was 47. Because brittle portions by precipitated ultrafine crystal grains and tough portions substantially free from ultrafine crystal grains were macroscopically mixed, part of the alloy ribbon could not be fracture-cut by the linear pressing method of the present invention. This appears to be due to the fact that a thin primary ultrafine-crystalline alloy ribbon was produced by a narrow gap and a high peripheral speed of the roll, failing to control the amount of ultrafine crystal grains precipitated. This tendency was appreciated commonly in Comparative Examples 1 to 5.

TABLE 6

| | Comparative Example 3 | | |
|---|---|---|---|
| Measurement | Distance from One | Vickers Hardness | Thickness |
| Point Line | Side Edge (mm) | (Hv) | (μm) |
| 1 | 2 | Hv₁ 788 | 18.1 |
| 2 | 5 | Hv₂ 816 | 18.3 |
| 3 | 12.5 | Hv₃ 800 | 18.8 |
| 4 | 20 | Hv₄ 807 | 18.2 |
| 5 | 23 | Hv₅ 769 | 18.1 |

In Comparative Example 6, the gap between the nozzle and the cooling roll was 320 μm, and the peripheral speed of the roll was 30 m/s, during casting. The Vickers hardness and thickness of the primary ultrafine-crystalline alloy ribbon measured in each measurement point line 1 to 5 in the same manner as in Example 1 are shown in Table 7. The Vickers hardness Hv in a center portion was 1127, and the Vickers hardness Hv in side portions was 928, both within a range of 850-1150, but the hardness difference was as large as 208. The thickness difference in a transverse direction was also as large as 25.6−23.1=2.5 μm. Accordingly, the alloy ribbon was extremely broken by shear cutting. Though it was cut in a fracture mode by the linear pressing method of the present invention, the percentage of notches was as high as 8.0%. It was found that a primary ultrafine-crystalline alloy ribbon obtained with a gap of 320 μm, wider than 300 μm, had large distributions of hardness and thickness, so that it could not be satisfactorily cut by the linear pressing method.

TABLE 7

| | Comparative Example 6 | | |
|---|---|---|---|
| Measurement | Distance from One | Vickers Hardness | Thickness |
| Point Line | Side Edge (mm) | (Hv) | (μm) |
| 1 | 2 | Hv₁ 933 | 23.1 |
| 2 | 5 | Hv₂ 1121 | 25.5 |
| 3 | 12.5 | Hv₃ 1130 | 25.6 |
| 4 | 20 | Hv₄ 1130 | 25.6 |
| 5 | 23 | Hv₅ 922 | 23.2 |

The alloy ribbon of Comparative Example 7 did not contain Cu acting as nuclei for ultrafine crystal grains, and the alloy ribbon of Comparative Example 8 had a small Cu content and contained a large amount of Nb suppressing fine crystallization. Accordingly, even when the same method as in Example 1 was used, amorphous alloy ribbons were produced in Comparative Examples 7 and 8.

In Comparative Example 7, the gap between the nozzle and the cooling roll was 180 μm, and the peripheral speed of the roll was 23 m/s, during casting. The Vickers hardness and thickness of the amorphous alloy ribbon measured in each measurement point line 1 to 5 in the same manner as in Example 1 are shown in Table 8. The Vickers hardness Hv of the amorphous alloy ribbon was less than 850 in both center and side portions, and as low as 801 as a whole. Accordingly, it could not be cut at all by the linear pressing method of the present invention, though it was cut in a shear-cutting mode.

In Comparative Example 8, the gap between the nozzle and the cooling roll was 180 μm, and the peripheral speed of the roll was 27 m/s, during casting. The amorphous alloy ribbon of Comparative Example 8 had Vickers hardness Hv of less than 850 in both center and side portions, and as low as 750 as a whole. Accordingly, it could not be cut at all by the linear pressing method of the present invention, though it was cut in a shear-cutting mode. This is due to the fact that like Comparative Example 7, the alloy ribbon of Comparative Example 8 was amorphous, having high toughness.

TABLE 8

| | Comparative Example 7 | | |
|---|---|---|---|
| Measurement | Distance from One | Vickers Hardness | Thickness |
| Point Line | Side Edge (mm) | (Hv) | (μm) |
| 1 | 2 | Hv₁ 800 | 23.8 |
| 2 | 10 | Hv₂ 804 | 23.8 |
| 3 | 25 | Hv₃ 802 | 24.3 |
| 4 | 40 | Hv₄ 800 | 24.0 |
| 5 | 48 | Hv₅ 799 | 23.9 |

In Example 6, the gap between the nozzle and the cooling roll was 250 μm, and the peripheral speed of the roll was 32 m/s, during casting. The Vickers hardness and thickness of the primary ultrafine-crystalline alloy ribbon measured in each measurement point line 1 to 5 in the same manner as in Example 1 are shown in Table 9. The alloy ribbon had Vickers hardness Hv within a range of 850-1150 in both center and side portions, with hardness difference of 52. The thickness difference in a transverse direction was as small as 23.7−22.7=1 μm. The primary ultrafine-crystalline alloy ribbon was fracture-cut substantially along a straight line by the linear pressing method of the present invention (fracture mode), with the percentage of notches as low as 2.0%.

TABLE 9

| | Example 6 | | |
|---|---|---|---|
| Measurement | Distance from One | Vickers Hardness | Thickness |
| Point Line | Side Edge (mm) | (Hv) | (μm) |
| 1 | 2 | Hv₁ 920 | 22.9 |
| 2 | 10 | Hv₂ 945 | 23.4 |
| 3 | 25 | Hv₃ 952 | 23.7 |
| 4 | 40 | Hv₄ 930 | 23.2 |
| 5 | 48 | Hv₅ 900 | 22.7 |

In Example 7, the gap between the nozzle and the cooling roll was 300 μm, and the peripheral speed of the roll was 35 m/s, during casting. The Vickers hardness and thickness of the primary ultrafine-crystalline alloy ribbon measured in each measurement point line 1 to 5 in the same manner as in Example 1 are shown in Table 10. The alloy ribbon had Vickers hardness Hv within a range of 850-1150 in both center and side portions, with hardness difference of 38. The thickness difference in a transverse direction was as small as 24.8−23.0=1.8 μm. The primary ultrafine-crystalline alloy ribbon was fracture-cut substantially along a straight line by the linear pressing method of the present invention (fracture mode), with the percentage of notches as low as 4.5%.

TABLE 10

| | Example 7 | | |
|---|---|---|---|
| Measurement | Distance from One | Vickers Hardness | Thickness |
| Point Line | Side Edge (mm) | (Hv) | (μm) |
| 1 | 2 | Hv₁ 932 | 23.0 |
| 2 | 10 | Hv₂ 960 | 23.8 |
| 3 | 25 | Hv₃ 970 | 24.8 |
| 4 | 40 | Hv₄ 966 | 24.2 |
| 5 | 48 | Hv₅ 939 | 23.0 |

Because the alloy melt of Example 8 had as large a Cu content as 1.6 atomic %, it could be formed into a relatively thin primary ultrafine-crystalline alloy ribbon. Even in such a thin ribbon, the Vickers hardness Hv in both center and side portions was in a range of 850-1150, with hardness difference of 70. Accordingly, the primary ultrafine-crystalline alloy ribbon was fracture-cut substantially along a straight line by the linear pressing method of the present invention (fracture mode), with the percentage of notches as low as 4.2%.

In Comparative Example 9, the gap between the nozzle and the cooling roll was 310 μm, and the peripheral speed of the roll was 35 m/s, during casting. The Vickers hardness and thickness of the primary ultrafine-crystalline alloy ribbon measured in each measurement point line 1 to 5 in the same manner as in Example 1 are shown in Table 11. The alloy ribbon had Vickers hardness Hv within a range of 850-1150 in both center and side portions, but its thickness difference in a transverse direction was as large as 25.6−23.3=2.3 μm, with hardness difference also as large as 191. As a result, the linear pressing method of the present invention generated notches as high as 5.5%.

TABLE 11

| | Comparative Example 9 | | |
|---|---|---|---|
| Measurement | Distance from One | Vickers Hardness | Thickness |
| Point Line | Side Edge (mm) | (Hv) | (μm) |
| 1 | 2 | Hv₁ 942 | 23.3 |
| 2 | 10 | Hv₂ 960 | 24.9 |
| 3 | 25 | Hv₃ 1133 | 25.6 |
| 4 | 40 | Hv₄ 1060 | 25.0 |
| 5 | 48 | Hv₅ 980 | 24.0 |

### Example 9

To investigate the relation between the percentage of notches and the gap without influence of the ribbon thickness, an alloy melt having a composition (atomic %) of Fe_{bal.}Cu_{1.4}Si₄B₁₄ was formed into primary ultrafine-crystalline alloy ribbons having a width of 25 mm and 50 mm, respectively, in the same manner as in Example 1 except for changing the gap as shown in Table 12, and changing the peripheral speed of the roll to provide the resultant ribbon with a constant thickness of 21 μm. It was confirmed that each ribbon had a structure in which ultrafine crystal grains having an average grain size of 30 nm or less were dispersed in a proportion of 5-30% by volume in an amorphous matrix. Next, each ribbon was measured with respect to hardness difference between a center portion and side portions, thickness difference in a transverse direction, and the percentage of notches generated when cutting was conducted by the linear pressing method of the present invention. The results are shown in Table 12. The percentage of notches was evaluated by the following standard.

Excellent: When the percentage of notches was 2% or less.

Good: When the percentage of notches was more than 2% and 5% or less.

Poor: When the percentage of notches was more than 5%.

TABLE 12

| | | | | | | Thickness |
|---|---|---|---|---|---|---|
| | | | Hardness | | | Difference |
| | Peripheral | Average | Difference (Hv) | | | in Width |
| Gap | Speed | Thickness | Width: | Width: | Percentage | Direction |
| (μm) | (m/s) | (μm) | 25 mm | 50 mm | of Notches | (μm) |
| 150 | 22 | 20.8 | 30 | 35 | Excellent | 0.4 |
| 180 | 25 | 20.5 | 50 | 50 | Excellent | 0.6 |
| 200 | 27 | 21.0 | 80 | 90 | Good | 0.8 |
| 250 | 31 | 21.1 | 80 | 90 | Good | 1.0 |
| 270 | 34 | 20.7 | 90 | 110 | Good | 1.4 |
| 300 | 36 | 20.6 | 140 | 145 | Good | 2.0 |
| 310 | 37 | 20.6 | 190 | 180 | Poor | 2.4 |

In both cases where the width was 25 mm and 50 mm, a larger gap provided larger hardness difference, more likely generating notches. Also, a larger gap provided larger thickness difference in a transverse direction. This means that a larger gap generates larger difference of a cooling speed in a transverse direction.

### Example 10

The primary ultrafine-crystalline alloy ribbon of Example 3 having a composition (atomic %) of Fe_{bal.}Ni₁Cu_{1.4}Si₄B₁₄ was subjected to a high-temperature, short-time heat treatment comprising heating to 430° C. in 15 minutes and then keeping that temperature for 15 minutes, to obtain a nanocrystalline, soft magnetic alloy ribbon comprising fine crystal grains having an average grain size of 20 nm dispersed at a volume ratio of 45%. Using a B—H loop tracer, this nanocrystalline, soft magnetic alloy ribbon was measured with respect to a magnetic flux density B₈₀₀₀ at 8000 A/m (substantially equal to a saturation magnetic flux density Bs), a magnetic flux density B₈₀ at 80 A/m, and coercivity Hc. As a result, B₈₀₀₀ was 1.81 T, B₈₀/B₈₀₀₀ was 0.93, and Hc was 7 A/m.

### Example 11

The primary ultrafine-crystalline alloy ribbon of Example 6 having a composition (atomic %) of Fe_{bal.}Cu_{1.4}Si₅B₁₃ was subjected to a low-temperature, long-time heat treatment comprising heating to 410° C. in 15 minutes and then keeping that temperature for 1 hour, to obtain a nanocrystalline, soft magnetic alloy ribbon comprising fine crystal grains having an average grain size of 20 nm dispersed at a volume ratio of 45%. The same measurement as in Reference Example 1 was conducted on a single plate sample produced from this alloy ribbon. As a result, B₈₀₀₀ was 1.79 T, B₈₀/B₈₀₀₀ was 0.94, and Hc was 6.8 A/m.

### Example 12

Each primary ultrafine-crystalline alloy ribbon of Examples 1 to 8 shown in Table 1 was cut by the linear pressing method of the present invention, and then subjected to the same high-temperature, short-time heat treatment as in Example 10. Observation revealed that the state of a cut portion and the percentage of notches were not changed by the heat treatment. Also, each primary ultrafine-crystalline alloy ribbon of Examples 1 to 8 was cut by the linear pressing method of the present invention, and then subjected to the same low-temperature, short-time heat treatment as in Example 11. Observation revealed that the state of a cut portion and the percentage of notches were also not changed by the heat treatment.

It is clear from Examples 10 to 12 that when a primary ultrafine-crystalline alloy ribbon cut by the linear pressing method of the present invention is heat-treated, a nanocrystalline, soft magnetic alloy ribbon having a high saturation magnetic flux density and low coercivity without changing the state of a cut portion and the percentage of notches is obtained, making it possible to produce magnetic devices having excellent soft magnetic properties.

### Comparative Examples 10 and 11

Each primary ultrafine-crystalline alloy ribbon obtained in Examples 1 and 7 was tried to be cut along a scratch line drawn by a diamond cutter. However, because a ribbon surface had slight undulation, and because keeping the pressure of a cutter constant was difficult, local fracture occurred, making it difficult to limit the percentage of notches within 5%, and thus failing to obtain a smooth cut cross section.

It may be said from the results of Examples 1 to 5 and 7 and Comparative Examples 1 to 6 and 9, etc. that the availability of the fracture mode by the linear pressing method of the present invention depends on the structure, hardness and hardness distribution of the alloy ribbon, regardless of its composition.

### Examples 13 to 41

By a single roll method using a cooling roll made of a copper alloy, each alloy melt (1300° C.) having a composition (atomic %) shown in Table 13 was quenched in the air, and stripped from the roll at a ribbon temperature of 250° C. to obtain a primary ultrafine-crystalline alloy ribbon having a width of 50 mm (Examples 13 to 19), 100 mm (Example 20), and 25 mm (Examples 21 to 41). To adjust the average grain size and volume fraction of ultrafine crystal grains and the Vickers hardness Hv of the primary ultrafine-crystalline alloy ribbon as shown in Table 13, the gap between the nozzle and the cooling roll was changed in a range of 150 μm to 300 μm, and the peripheral speed of the roll was changed in a range of 23-36 m/s, during casting. Each primary ultrafine-crystalline alloy ribbon was measured as in Examples 1 to 8 with respect to average thickness, Vickers hardness Hv, the average grain size and volume fraction of ultrafine crystal grains, and the percentage of notches when cut by the linear pressing method of the present invention. The results are shown in Table 13.

TABLE 13

| | | | Ultrafine | |
|---|---|---|---|---|
| | | | Crystal Grains | |
| | | | Average | |
| | | Average | Grain | Amount |
| | Composition | Thickness | Size | (% by |
| No. | (atomic %) | (μm) | (nm) | volume) |
| Example 13 | Fe_{bal.}Cu_{1.3}Si₅B₁₃ | 25.1 | 3 | 15 |
| Example 14 | Fe_{bal.}Cu_{1.2}Si₃B₁₅ | 26.3 | 5 | 18 |
| Example 15 | Fe_{bal.}Cu_{1.25}Si₂B₁₅ | 25.2 | 5 | 20 |
| Example 16 | Fe_{bal.}Cu_{1.4}Si₄B₁₃ | 22.4 | 3 | 15 |
| Example 17 | Fe_{bal.}Cu_{1.35}Si₄B₁₃ | 23.5 | 3 | 15 |
| Example 18 | Fe_{bal.}Cu_{1.25}Si₁B₁₇ | 21.1 | 10 | 25 |
| Example 19 | Fe_{bal.}Cu_{1.4}Si₆B₁₂ | 25.5 | 3 | 15 |
| Example 20 | Fe_{bal.}Cu_{1.3}Si₂B₁₆ | 22.1 | 10 | 25 |
| Example 21 | Fe_{bal.}Cu_{1.25}Si₂B₁₄ | 22.2 | 8 | 20 |
| Example 22 | Fe_{bal.}Cu_{1.45}Si₇B₁₂ | 25.9 | 3 | 15 |
| Example 23 | Fe_{bal.}Cu_{1.6}Si₇B₁₂ | 20.0 | 8 | 20 |
| Example 24 | Fe_{bal.}Cu_{1.2}Si₄B₁₇ | 26.8 | 10 | 25 |
| Example 25 | Fe_{bal.}Cu_{1.4}Si₇B₁₁ | 26.0 | 5 | 20 |
| Example 26 | Fe_{bal.}Cu_{1.4}Si₅B₁₂ | 23.7 | 5 | 18 |
| Example 27 | Fe_{bal.}Cu_{1.3}Si₃B₁₃ | 24.1 | 5 | 22 |
| Example 28 | Fe_{bal.}Cu_{1.3}Si₃B₁₄ | 24.3 | 5 | 20 |
| Example 29 | Fe_{bal.}Cu_{1.4}Si₃B₁₄ | 22.2 | 10 | 28 |
| Example 30 | Fe_{bal.}Cu_{1.3}B₁₅ | 18.2 | 10 | 20 |
| Example 31 | Fe_{bal.}Cu_{1.25}B₁₆ | 18.4 | 10 | 20 |
| Example 32 | Fe_{bal.}Cu_{1.25}B₁₇ | 20.1 | 10 | 25 |
| Example 33 | Fe_{bal.}Cu_{1.2}B₁₈ | 21.3 | 15 | 25 |
| Example 34 | Fe_{bal.}Cu_{1.4}B₁₂P₄ | 22.5 | 5 | 10 |
| Example 35 | Fe_{bal.}Cu_{1.5}B₁₀P₆ | 23.0 | 3 | 10 |
| Example 36 | Fe_{bal.}Cu_{1.4}Si₂B₁₂P₂ | 23.5 | 3 | 10 |
| Example 37 | Fe_{bal.}Cu_{1.5}Si₂B₁₀P₄ | 24.6 | 3 | 10 |
| Example 38 | Fe_{bal.}Cu_{1.6}Si₈B₁₀ | 24.8 | 3 | 10 |
| Example 39 | Fe_{bal.}Cu_{1.4}Si₆B₁₁ | 25.1 | 3 | 15 |
| Example 40 | Fe_{bal.}Cu_{1.25}Si₄B₁₃Ag_{0.05} | 23.1 | 3 | 15 |
| Example 41 | Fe_{bal.}Cu_{1.28}Si₄B₁₃Sn_{0.05} | 23.5 | 3 | 15 |

| | Vickers Hardness | | | | | |
|---|---|---|---|---|---|---|
| | (Hv) | | | | Linear Cutting | |
| | In | | | | Method | |
| | Center | In Side | Hardness | Entire | Fracture | Notches |
| No. | Portion | Portions | Difference | Ribbon | Mode | (%) |
| Example 13 | 905 | 888 | 17 | 895 | Yes | 2.1 |
| Example 14 | 919 | 872 | 47 | 899 | Yes | 2.2 |
| Example 15 | 950 | 892 | 58 | 921 | Yes | 3.1 |
| Example 16 | 920 | 872 | 48 | 892 | Yes | 1.8 |
| Example 17 | 925 | 880 | 45 | 901 | Yes | 2.4 |
| Example 18 | 954 | 890 | 64 | 910 | Yes | 3.1 |
| Example 19 | 970 | 901 | 69 | 954 | Yes | 3.1 |
| Example 20 | 1021 | 871 | 150 | 980 | Yes | 4.8 |
| Example 21 | 988 | 912 | 76 | 966 | Yes | 3.9 |
| Example 22 | 910 | 852 | 58 | 891 | Yes | 0.8 |
| Example 23 | 999 | 912 | 87 | 954 | Yes | 2.4 |
| Example 24 | 1012 | 905 | 107 | 971 | Yes | 4.1 |
| Example 25 | 1015 | 915 | 100 | 968 | Yes | 3.3 |
| Example 26 | 952 | 898 | 54 | 915 | Yes | 2.2 |
| Example 27 | 988 | 919 | 69 | 942 | Yes | 3.8 |
| Example 28 | 987 | 902 | 85 | 950 | Yes | 2.8 |
| Example 29 | 1140 | 995 | 145 | 1016 | Yes | 4.7 |
| Example 30 | 1032 | 960 | 72 | 994 | Yes | 4.0 |
| Example 31 | 1005 | 972 | 33 | 995 | Yes | 4.1 |
| Example 32 | 1051 | 971 | 80 | 1010 | Yes | 1.6 |
| Example 33 | 1098 | 999 | 99 | 1052 | Yes | 4.9 |
| Example 34 | 915 | 855 | 50 | 892 | Yes | 1.2 |
| Example 35 | 905 | 860 | 45 | 888 | Yes | 1.5 |
| Example 36 | 920 | 862 | 78 | 901 | Yes | 1.8 |
| Example 37 | 911 | 872 | 39 | 899 | Yes | 1.2 |
| Example 38 | 921 | 852 | 69 | 897 | Yes | 0.5 |
| Example 39 | 935 | 860 | 75 | 904 | Yes | 1.9 |
| Example 40 | 921 | 871 | 50 | 895 | Yes | 0.8 |
| Example 41 | 930 | 885 | 45 | 900 | Yes | 0.9 |

The present invention is applicable not only to the compositions in Examples above, but also to any compositions enabling ultrafine crystallization utilizing the formation of non-uniform nuclei in an amorphous matrix.

### Effects of the Invention

The primary ultrafine-crystalline alloy ribbon of the present invention having a structure in which ultrafine crystal grains are precipitated to have hardness in a predetermined range with small hardness distribution can be cut along a straight line to have a rectangular cross section. Also, when the primary ultrafine-crystalline alloy ribbon is cut on an elastically deformable, soft base by the linear pressing method, a fracture-cut cross section with little notches such as jaggedly broken portions, etc. are obtained. Because the elastically deformable, soft base makes it possible to stably fracture-cut the primary ultrafine-crystalline alloy ribbon along a straight line regardless of its thickness and hardness, the method of the present invention using such base has wide applications. Because a cutter is simply pressed to the primary ultrafine-crystalline alloy ribbon in the method of the present invention, the cutter does not suffer wear in its blade edge, enabling its use for a long period of time.

Because the nanocrystalline, soft magnetic alloy ribbon of the present invention obtained by heat-treating the fracture-cut primary ultrafine-crystalline alloy ribbon has a smooth, linear fracture-cut cross section substantially free from cracks and jaggedness, it can be provide magnetic devices such as cores, etc. having designed soft magnetic properties.

1-10. (canceled)

11. A primary ultrafine-crystalline alloy ribbon having a composition represented by the general formula of Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions of 0<x≦5, 10≦y≦22, 0≦z≦10, and x+y+z≦25, respectively, when expressed by atomic %, and having a structure in which ultrafine crystal grains having an average grain size of 30 nm or less are dispersed in a proportion of 5-30% by volume in an amorphous matrix;
said primary ultrafine-crystalline alloy ribbon having a width of 10 mm or more and a thickness of 15 μm or more, with thickness difference of 2 μm or less in a transverse direction;
said primary ultrafine-crystalline alloy ribbon having Vickers hardness Hv (measured at a load of 100 g) of 850-1150 in both center and side portions in a transverse direction; and
the difference of Vickers hardness Hv (measured at a load of 100 g) between the center portion and the side portions being 150 or less.

12. The primary ultrafine-crystalline alloy ribbon according to claim 11, which has higher Vickers hardness Hv (measured at a load of 100 g) in the center portion than in the side portions.

13. The primary ultrafine-crystalline alloy ribbon according to claim 11, which has Vickers hardness Hv (measured at a load of 100 g) of 850-1100 in both center and side portions in a transverse direction.

14. The primary ultrafine-crystalline alloy ribbon according to claim 12, which has Vickers hardness Hv (measured at a load of 100 g) of 850-1100 in both center and side portions in a transverse direction.

15. A method for cutting a primary ultrafine-crystalline alloy ribbon having a structure in which ultrafine crystal grains having an average grain size of 30 nm or less are dispersed in a proportion of 5-30% by volume in an amorphous matrix; said ribbon having a width of 10 mm or more and a thickness of 15 μm or more, with thickness difference being 2 μm or less in a transverse direction, and having Vickers hardness Hv (measured at a load of 100 g) of 850-1150 in both center and side portions in a transverse direction, the difference of Vickers hardness Hv (measured at a load of 100 g) between the center portion and the side portions being 150 or less; which comprises the steps of
placing said primary ultrafine-crystalline alloy ribbon on a soft base deformable to an acute angle by local pressing;
bringing a cutter blade into horizontal contact with a surface of said primary ultrafine-crystalline alloy ribbon; and
pressing said cutter to said primary ultrafine-crystalline alloy ribbon to apply uniform pressure thereto, thereby bending said primary ultrafine-crystalline alloy ribbon along a blade edge of said cutter to fracture-cut it.

16. The method for cutting a primary ultrafine-crystalline alloy ribbon according to claim 15, wherein said base is a laminate of an upper layer formed by a rubber sheet and a lower layer formed by a sponge.

17. The method for cutting a primary ultrafine-crystalline alloy ribbon according to claim 16, wherein said rubber sheet is a sheet of natural or synthetic rubber having a thickness of 0.3-2 mm, and said sponge is a foamed rubber or resin having a thickness of 2-30 mm.

18. A nanocrystalline, soft magnetic alloy ribbon obtained by heat-treating a primary ultrafine-crystalline alloy ribbon having a composition represented by the general formula of Fe_{100-x-y-z}AₓB_{y}X_{z}, wherein A is Cu and/or Au, X is at least one element selected from the group consisting of Si, S, C, P, Al, Ge, Ga and Be, and x, y and z are numbers meeting the conditions of 0<x≦5, 10≦y≦22, 0≦z≦10, and x+y+z≦25, respectively, when expressed by atomic %, and having a structure in which ultrafine crystal grains having an average grain size of 30 nm or less are dispersed in a proportion of 5-30% by volume in an amorphous matrix; said primary ultrafine-crystalline alloy ribbon having a width of 10 mm or more and a thickness of 15 μm or more, with thickness difference of 2 μm or less in a transverse direction, and Vickers hardness Hv (measured at a load of 100 g) of 850-1150 in both center and side portions in a transverse direction; the difference of Vickers hardness Hv (measured at a load of 100 g) between the center portion and the side portions being 150 or less;
said nanocrystalline, soft magnetic alloy ribbon having a structure in which fine crystal grains having an average grain size of 60 nm or less are dispersed in a proportion of 30% or more by volume in an amorphous matrix, and being fracture-cut along a cutter blade in horizontal contact with a surface of said ribbon before or after the heat treatment;
when notches are generated along the fracture-cut portion of said ribbon, the percentage of said notches being 5% or less, which is determined by the following formula:
Percentage of notches=(Dav/D)×100(%),
wherein D is the width of said ribbon, Dav is an average depth of said notches, which is obtained by dividing the total area of said notches by the width D of said ribbon.

19. The nanocrystalline, soft magnetic alloy ribbon according to claim 18, wherein said cut portion at least partially has a cross section formed by brittle fracture.

20. The nanocrystalline, soft magnetic alloy ribbon according to claim 18, wherein said notches are free from acute-angle corners.

21. The nanocrystalline, soft magnetic alloy ribbon according to claim 19, wherein said notches are free from acute-angle corners.

22. A magnetic device formed by the nanocrystalline, soft magnetic alloy ribbon recited in claim 18.
